(19) United States
(12) Patent Application Publication
(10) Pub. No.: US 2013/0339400 A1
(43) Pub. Date: Dec. 19, 2013

(54) SYSTEM AND METHOD FOR MOBILE MULTI-TENANT DATABASE SYSTEM MANAGEMENT

(71) Applicant: Salesforce.com, Inc., San Francisco, CA (US)

(72) Inventor: Kennen Pflughoeft, Oakland, CA (US)

(21) Appl. No.: 13/904,754

(22) Filed: May 29, 2013

Related U.S. Application Data
(60) Provisional application No. 61/652,607, filed on May 29, 2012.

(51) Int. Cl. G06F 17/30

(52) U.S. Cl. CPC G06F 17/30289
USPC 707/803

(57) ABSTRACT

A system, method, and mobile device application for managing a multi-tenant database system from a mobile device. An administrator of a multi-tenant database system is enabled to view information relating to managing the multi-tenant database from a mobile device. Some examples of the information that may be viewed include the status of datacenters, the status of instances on a datacenter, the status of user accounts, notifications to alert the administrator of changes within the multi-tenant database, alerts of potential problems. In an embodiment, the management of a multi-tenant database is further facilitated by the ability to send and implement administrative actions at the multi-tenant database, via the mobile device application. The system, method, and mobile device application may allow the administrator to perform database management duties without the restrictions of business hours or location, and without the use of a desktop or laptop computer.

### CLAIM OF PRIORITY

This application claims the benefit of U.S. Provisional Patent Application 61/652,607 entitled “SYSTEM AND METHOD FOR MOBILE MULTI-TENANT DATABASE SYSTEM MANAGEMENT,” by Kennen Pflughoeft, filed May 29, 2012, (Attorney Docket No. 48-91/900PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

The following commonly owned, co-pending United States Patents and Patent Applications, including the present application, are related to each other. Each of the other patents/applications are incorporated by reference herein in its entirety: U.S. patent application Ser. No. 61/663,042, entitled “PRIORITY-BASED NOTIFICATIONS FOR MOBILE DEVICES,” by Mohamad Arabo et al., filed Jun. 22, 2012, Attorney Docket No. 48-97/906PROV, and U.S. patent application Ser. No. 13/904,754 entitled “SYSTEM AND METHOD FOR MOBILE MULTI-TENANT DATABASE SYSTEM MANAGEMENT,” by Kennen PFLUGHOEFT et al., filed May 29, 2013 Attorney Docket No. 48-92/900US.

### FIELD OF THE INVENTION

The current invention relates generally to managing a multi-tenant database system using a mobile device.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In a multi-tenant database system, users are segregated by organization as individual tenants. Each organization may have one or more administrators with sufficient privileges to manage one or more users of the multi-tenant database system. In some instances, the one or more administrators may manage two or more tenants in the multi-tenant database system. Administrative duties may include adding users, removing users, changing a user's access privileges, editing a user's profile, resetting a user's password, monitoring database statistics, etc. Such duties are typically performed by accessing a special administrative web page or console using a desktop or laptop computer.

While it would be ideal if the administrator's call of duty was limited to business hours or whenever the administrator has ready access to a desktop or laptop computer, that is simply not business reality. Issues that require administrative intervention can happen any time of day, and does not consider the convenience of the administrator.

### BRIEF SUMMARY

In accordance with embodiments, there are provided mechanisms and methods for managing a multi-tenant database system. These mechanisms and methods for managing a multi-tenant database can enable embodiments to allow administrators to respond to occurrences in the systems or to actions by users in the systems without having to access the system through a desktop or laptop computer during business hours. The ability of embodiments to provide the administrator with around-the-clock access and privileges provides an advantage over other systems.

In an embodiment and by way of example, a method for managing a multi-tenant database on a mobile device, such as a smartphone, is provided. The method embodiment includes methods for managing users and monitoring databases by the use of an application running on the mobile device allowing the administrator to manage the databases.

Alternative embodiments include the use of a web page formatted for access on a mobile device, rather than a native application running on the mobile device.

While the present invention is described with reference to an embodiment in which a multi-tenant database is managed through a mobile device by an administrator of the multi-tenant database, the present invention is not limited to the use by an administrator. In an embodiment, tenants may be organizations with employees and customers, whom may be users of the multitenant database as a result of the organization being a tenant of the multitenant database and access may be granted to authorized users who are employees or customers of the organizations. Embodiments may be practiced using other database architectures, i.e., ORACLE®, DB2®, by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 shows a block diagram of an embodiment of an alert monitoring system.

FIG. 2 shows a block diagram of an embodiment of an alert configuration setting system.

FIG. 3 shows a block diagram of an embodiment of a user management system.

FIG. 4 shows a block diagram of an embodiment of a status monitoring system.

FIG. 5 shows a flow diagram of an embodiment of a general user interface for the login of a system for mobile multi-tenant database management.

FIG. 6 shows a flow diagram of an embodiment of a general user interface for an alert monitoring system.

FIG. 7 shows a flow diagram of an embodiment of a general user interface for a user management system.

FIG. 8 shows a flow diagram of an embodiment of a general user interface for a status monitoring system.

FIG. 9 shows the first part of a flow diagram of an embodiment of a server-side method of managing alerts of a multi-tenant database system on a mobile device.

FIG. 10 shows the second part of a flow diagram of an embodiment of a server-side method of managing alerts of a multi-tenant database system on a mobile device.

FIG. 11 shows the third part of a flow diagram of an embodiment of a server-side method of managing alerts of a multi-tenant database system on a mobile device.

FIG. 12A shows the fourth part of a flow diagram of an embodiment of a server-side method of managing alerts of a multi-tenant database system on a mobile device.

FIG. 12B shows the fourth part of a flow diagram of an embodiment of a server-side method of managing alerts of a multi-tenant database system on a mobile device.

FIG. 13 shows a screenshot of an embodiment of a login page for a system for mobile multi-tenant database management.

FIG. 14 shows a screenshot of an embodiment of an alerts monitoring page.

FIG. 15 shows a screenshot of an embodiment of another view of an alerts monitoring page.

FIG. 16 shows a screenshot of an embodiment of a password request action on an alerts monitoring page.

FIG. 17 shows a screenshot of an embodiment of a status update action on an alerts monitoring page.

FIG. 18 shows a screenshot of an embodiment of another view of an action on an alerts monitoring page.

FIG. 19 shows a screenshot of an embodiment of an archived alerts page.

FIG. 20 shows a screenshot of an embodiment of an alerts settings page.

FIG. 21 shows a screenshot of an embodiment of a user requests settings page.

FIG. 22 shows a screenshot of an embodiment of a user alerts setting page.

FIG. 23 shows a screenshot of an embodiment of an organization limits settings page.

FIG. 24 shows a screenshot of an embodiment of an instance limits settings page.

FIG. 25 shows a screenshot of an embodiment of a user directory page.

FIG. 26 shows a screenshot of an embodiment of a user information page.

FIG. 27 shows a screenshot of an embodiment of an action confirmation for user information page.

FIG. 28 shows a screenshot of an embodiment of an add new user page.

FIG. 29 shows a screenshot of an embodiment of an edit user information page.

FIG. 30 shows a screenshot of an embodiment of a status monitoring page.

FIG. 31 shows a screenshot of an embodiment of another view of a status monitoring page.

FIG. 32 shows a screenshot of an embodiment of reporting mechanisms within a status monitoring page.

FIG. 33 shows another screenshot of an embodiment of reporting mechanisms within a status monitoring page.

FIG. 34 shows a screenshot of an embodiment of another view of a status monitoring page.

FIG. 35 shows a screenshot of an embodiment of another implementation of the mobile multi-tenant database management system.

FIG. 36 shows a screenshot of an embodiment of a confirmation screen for approval to install the “iContact” application.

FIG. 37 illustrates a block diagram of an environment in which an on-demand database service is be used.

FIG. 38 also illustrates details of the environment of FIG. 37.

FIG. 39 shows a flowchart of an example of a method of using the environment of FIGS. 37 and 38.

FIG. 40 is a flowchart of an example of a method of making the environment of FIGS. 37 and 38.

### DETAILED DESCRIPTION

Systems and methods are provided for managing a multi-tenant database on a mobile device. The following detailed description may first describe examples of components for managing a multi-tenant database in accordance with aspects and embodiments of the present invention. A block diagram of a document is then detailed. Unless otherwise stated, the term “user” in the detailed description refers to the user of the described system or method. Unless otherwise stated, the term “administrator” in the detailed description refers to the administrator using the claimed system and method for multi-tenant database management. In this specification, the word “page” is generic to both a webpage generated by the multitenant database or other server and to a display rendered on a user device that is not a webpage, but just the interface rendered on the user device.

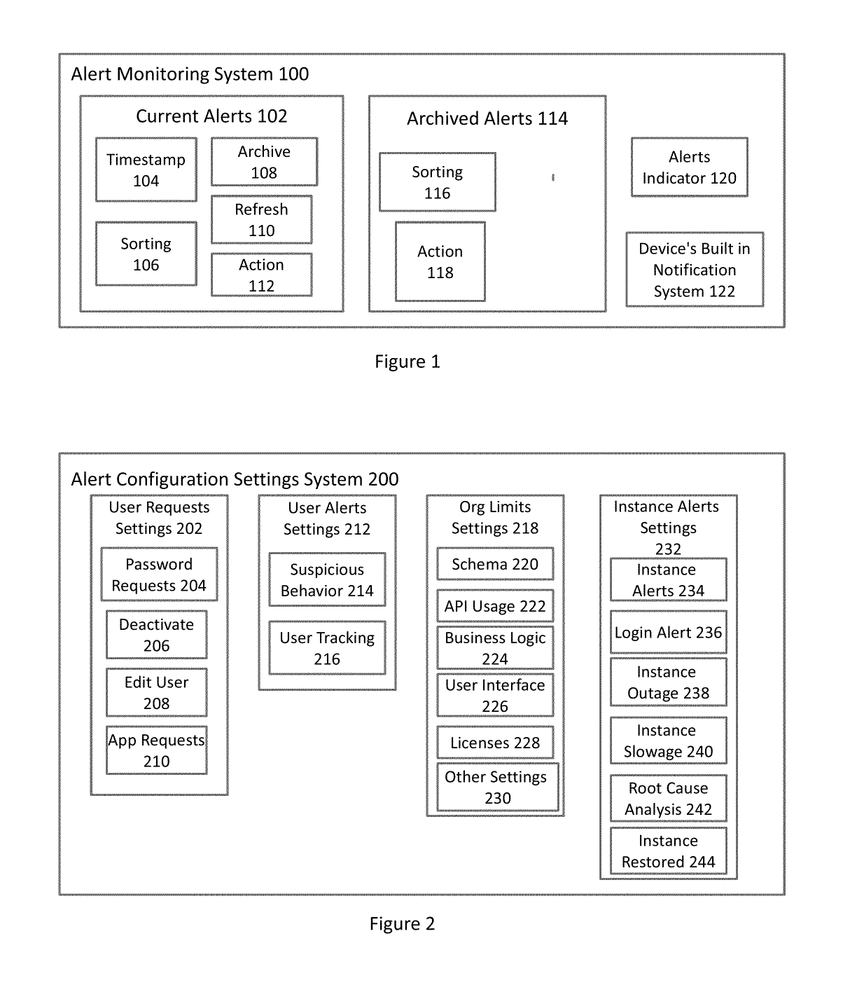

FIG. 1 shows a block diagram of an embodiment of alert monitoring system 100. Alert monitoring system 100 includes a current alerts module 102, an archived alerts module 114, and an alerts indicator 120. The alert monitoring system is also connected to a built-in notification system of the mobile device 122. The current alerts module 102 may include a timestamp module 104, a sorting module 106, an archiving program 108, a refresh program 110, and an action program 110. The archived alerts module 114 may include a sorting program 116 and an action program 118. In other embodiments alert monitoring system 100 may have additional components and/or may not have all components listed above.

Alert monitoring system 100 notifies the administrator of the status of the multi-tenant database with alerts. In this specification the terms alert monitoring system 100, user system and user mobile device are used interchangeably. The terms alert monitoring system 100, user system and user mobile device may be substituted one for another to obtain different embodiments. The terms multitenant database and server are used interchangeably. The terms multitenant database and server may be substituted one for another to obtain different embodiments.

Current alerts 102 is a module that presents the most recent alerts to the administrator. Timestamp module 104 places a time stamp on the alert based on when the alert is received. The alert may also have a timestamp associated with the alert from the database. Sorting module 106 sorts the current alerts according to preferences selected by user. Archiving program 108 is a function that transfers alerts to a storage area (e.g., an archive) for an archived alerts list. For example, the administrator may select an icon or key while the alert is selected, and in response, the alert is automatically sent to the archived alerts module 114. The alert may also be automatically sent to the archived alerts module 114 after an appropriate action has been taken. Refresh program 110 resets the alerts page to show the current alerts that are outstanding. Action 112 is a function that implements one of several actions to take regarding the alerts in current alerts 102, based on the administrator's selection among possible actions. Depending upon the nature of the alert, such actions may include but are not limited to sending a status to another user, delegating the alert to another user, resetting a password, or deleting the alert.

Archived alerts module 114 collects and organizes alerts upon the administrator taking the required action or upon the administrator's request to archive an alert. The archived alerts module has a sorting program and an action program. Sorting program 116 is a function that sorts the alerts in archived alerts module 114 according to preferences selected by the administrator. Action program 118 is a function that allows the user to select various actions to take regarding the alerts in archived alerts module 114. Depending upon the nature of the alert, action program 118 may include but are not limited to sending a status to another administrator, delegating the alert to another administrator, resetting a password, or deleting the alert.

Alerts indicator 120 is a module that calculates the number of current pending alerts and displays the number to the administrator within the program. The device's built-in monitoring system 122 is a program on the administrator's device that informs the administrator of any notifications or alerts occurring in the applications installed on the device. The alert monitoring system 100 may also communicate with the device's built-in notification system 122 to display the number of current pending alerts to the user outside of the program. Alert monitoring will be discussed, further below, in conjunction of FIGS. 2, 6, 10, 14-24.

FIG. 2 shows a block diagram of an embodiment of alert configuration settings system 200. Alert configuration settings system 200 includes a user requests settings module 202, a user alerts settings module 212, an organization limits settings module 218, and an instance alerts settings 232. The available settings include the option to receive password requests 204, deactivate 206, edit user 208, app request 210, suspicious behavior 214, user tracking 216, schema 220, API usage 222, business logic 224, user interface 226, licenses 228, other settings 230, instance alerts 232, login alerts 234, instance outage 238, and instance slowage 240, root cause analysis 242, and instance restored 244. In other embodiments alert configuration settings system 200 may have additional components and/or may not have all components listed above.

The administrator can access the alert configurations settings system 200 to customize which alerts to receive on the administrator's device. The user requests settings module 202 presents a page where the administrator can select which alerts pertaining to user requests the administrator wishes to receive, including password requests 204, deactivate 206, edit user 208, and app request 210. Password requests 204 alerts the administrator upon the request to reset the user's password. Deactivate 206 alerts the administrator upon the request to deactivate the user's account. Edit user 208 alerts the administrator upon a request to edit a user's permission of access to the database or increasing or decreasing the user's authorized functions. App request 210 alerts the administrator upon a request by an organization to grant access to a user to the database or to download an application. Requests can be made by a user, a manager, an organization, or another administrator of the system.

The user alerts settings module 212 presents a page where the administrator can select which alerts to receive pertaining to user activity, including suspicious behavior 214 and user tracking 216. Suspicious behavior 214 alerts the administrator when a predetermined event occurs that has been deemed to warrant further attention. User tracking 216 alerts the administrator of actions taken by a user that the administrator wishes to monitor more closely.

The organization limits settings module 202 presents a page where the administrator can select which alerts to receive pertaining to when an organization or customer has reached a certain usage limit, such as schema 220, API usage 222, business logic 224, user interface 226, licenses 228, or other settings 230. Schema 220 alerts the administrator when an organization has reached a set limit on the number of objects or connections between objects within a given schema. API usage 222 alerts the administrator when an organization has reached a set limit on the amount actions taken on a particular API. Business logic 224 alerts the administrator when an organization has reached a set limit of work flows created. User interface 226 alerts he administrator when an organization has reached a set limit of proprietary user interfaces (visual force pages). Licenses 228 alerts the administrator when an organization has issued a set limit of licenses. Other settings 230 may include other settings determining organization limits.

The instance alerts settings module 232 presents a page where the administrator can select which alerts to receive pertaining to the real-time system performance and status of various datacenters and/or instances. Datacenters and instances being monitored include, but are not limited to, Salesforce's North America instances, APAC instances, EMEA instances, and Sandbox instances. The administrator can choose to be notified of, but is not limited to be notified of, whether a particular datacenter or instance is available, experiencing performance issues, experiencing a service disruption, has an informational message, or whether the status is not available. Instance alerts 232 alerts the administrator of a change in status or performance of a datacenter or instance. Login alerts 234 are similar to instance alerts 232, but login alerts 234 alerts the administrator of a change in status or performance of a particular login on a particular instance within a datacenter. Instance outage 238 alerts he administrator when there is a service disruption for a particular instance or login. Instance slowage 240 alerts the administrator when there are performance issues for a particular instance or login within a datacenter. Root cause analysis 242 alerts he administrator if there is information regarding a change in the status or performance of an instance or login within a datacenter. Instance restored 244 alerts the administrator if a particular instance or login that was previously experiencing performance issues or service disruption has regained operability. Alert monitoring was discussed, above, in conjunction with FIG. 1, and will be discussed, further below, in conjunction of FIGS. 6, 10, and 14-24.

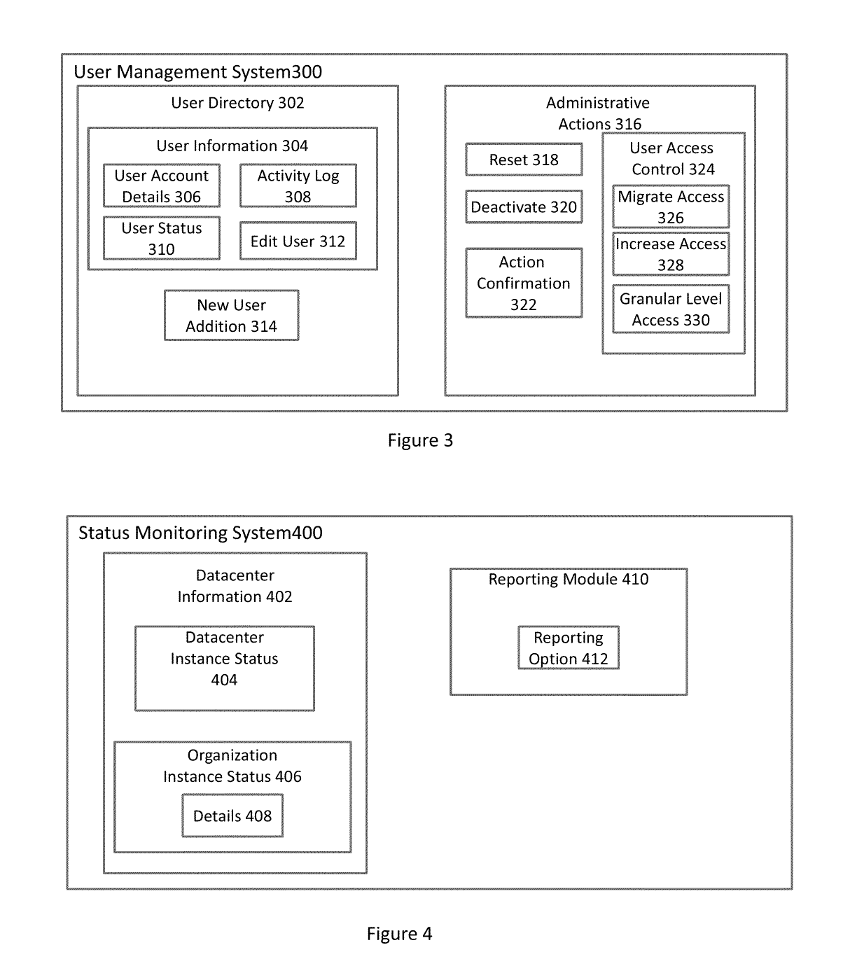

FIG. 3 shows a block diagram of an embodiment of user management system 300. User management system 300 includes a user directory 302, provides a new user addition 314 program and an edit user 321 program, may display user information page 304, and lists user account details 306, activity log 308, and/or user status 310. User management system 300 also includes an administrative actions module 316, which includes action programs such as reset 318, deactivate 320, action confirmation 322, as well as a user access control module 324, which includes programs such as migrate access 326, increase access 328, and granular level access 330. In other embodiments user management system 300 may have additional components and/or may not have all components listed above.

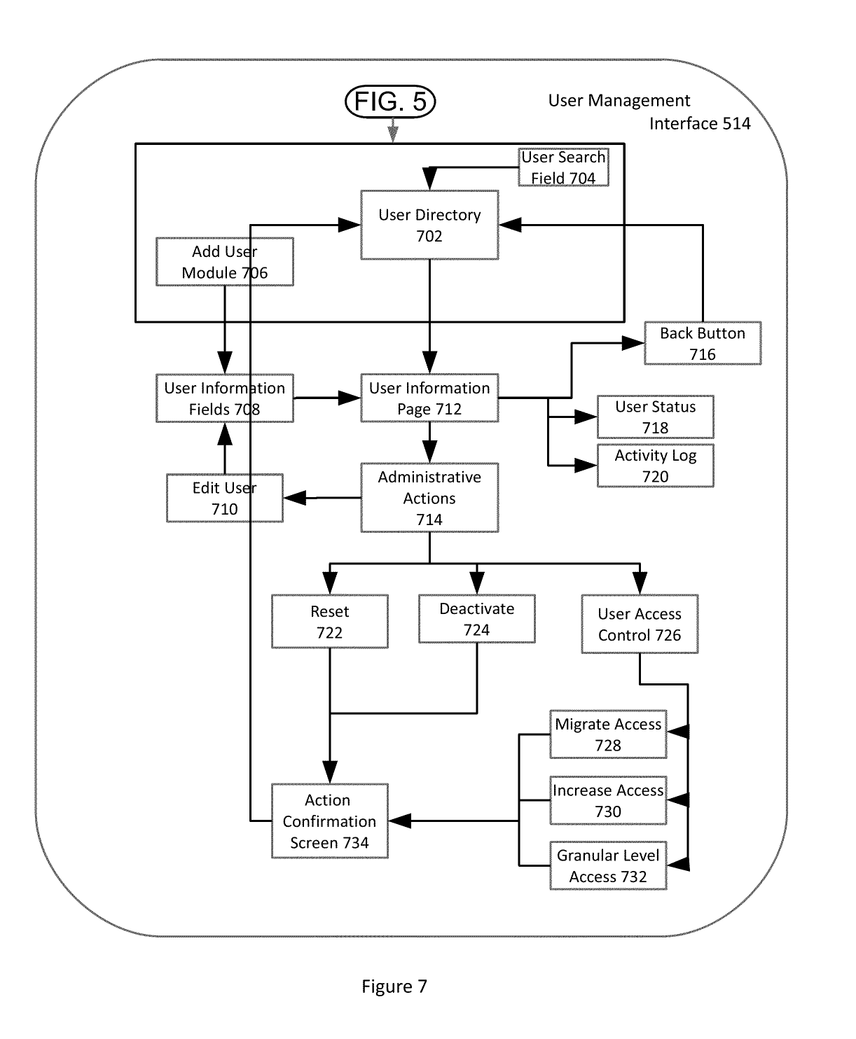

The administrator can use the user management system 300 to view or edit user information, and control access and permissions of particular users. User directory 302 displays a list page of all users that have been assigned to the administrator to manage. Each user displayed on the list page may include a symbol indicating a change in the user's status on the database. Through this list page the administrator may access a new user addition 314 program to create a user profile for a new user and input information including name, profile type, role, manager, title, contact information, and other permissions. The administrator may also access existing user information by selecting a particular user's user information page 304. The user information page 304 displays user account details 306 and shows all information previously input for the particular user. The user information page 304 also displays the particular users activity log 308 and lists details, such as a login and/or activity history. In another location of the user information page 304, the user status 310 is displayed and may indicate any change in the user's status on the database and may further explain any symbols that were displayed on the list page of the user directory 302. The administrator may also access and edit user 312 program from the user information page 304 to edit the user's profile and change information including name, profile type, role, manager, title, contact information, and other permissions. User management system 300 also includes an administrative actions module 316 that may be accessed through the user information page 304. The administrator can use administrative actions module 316 to take various administrative actions using programs such as reset 318 and deactivate 320. Reset 318 may reset a user's account password. Deactivate 320 may deactivate a user's account password. The administrator with privileges over multiple organizations and/or instances may also customize a user's access to data by using user access control module 324. From the user access control module 324, an administrator may be able to migrate or increase user access to different organizations and/or instances by selecting the migrate access 326 program or increase access 328 program, respectively. The administrator may configure the user's access to certain data depending on the user's location as indicated by the user's mobile device or computer by using the granular level access 330 program. Because an action taken can affect user access, each action taken may require confirmation by the administrator via action confirmation program 322. User Management will be discussed further in conjunction with FIGS. 7, 11, and 25-29.

FIG. 4 shows a block diagram of an embodiment of status monitoring system 400. Status monitoring system 400 includes datacenter information module 402 containing the following programs: status 404, organization instance status 406, and details 408. Status monitoring system 400 also includes a reporting module 410 and provides reporting option 412. In other embodiments status monitoring system 400 may have additional components and/or may not have all components listed above.

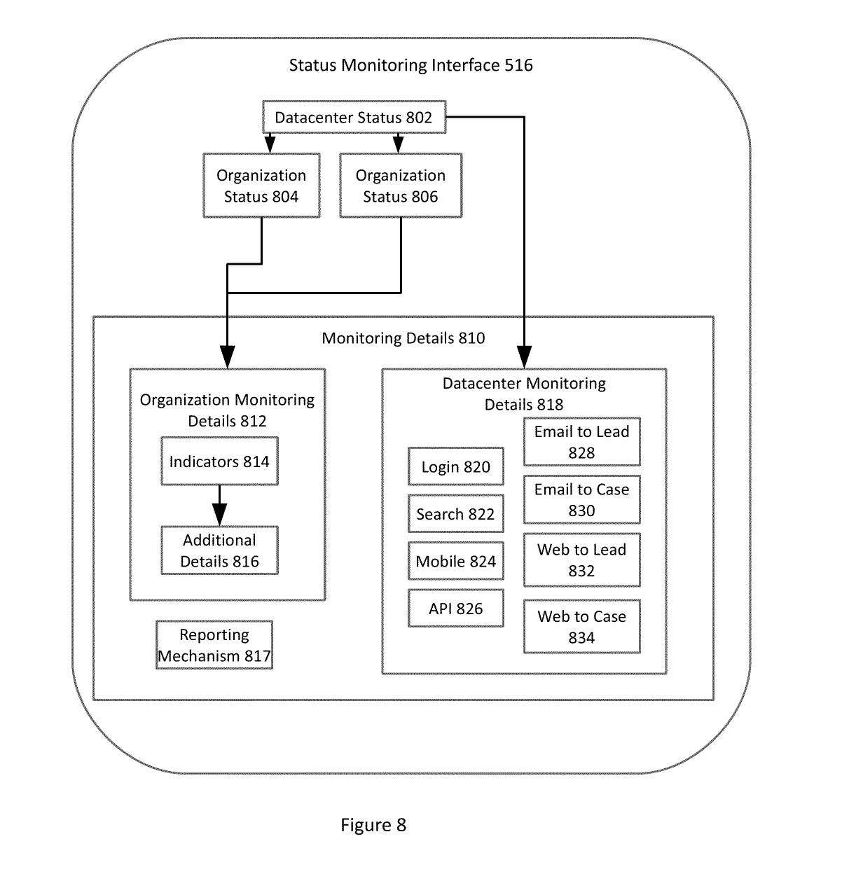

Status monitoring system 400 gives the administrator the ability to monitor the status of an instance, a datacenter, or a server. Datacenter information module 402 includes detailed information on a datacenter or instance through program datacenter instance status 404 from which the administrator may check statuses such as: login, search, mobile, API, email to lead, email to case, web to lead, and/or web to case. Datacenter information module 402 may also display details for an organization instance using program organization instance status 406. Datacenter information module 402 may also use program details 408 to display particular statistics of a particular organization instance, such as: user requests per day, or logins per day. Datacenter information module 402 may include information for one or multiple datacenter and organization instances. Reporting module 410 provides a program reporting option 412 that provides the administrator various reporting mechanisms that can be used to transmit information to others regarding datacenter and instance statuses. Reporting mechanisms provided by reporting option 412 include email, chatter, text, or tweet. In other embodiments reporting module 410 may have additional reporting mechanisms and/or may not have all reporting mechanisms listed above. Status monitoring will also be discussed further, below, in conjunction with FIGS. 8 and 12, 30-34

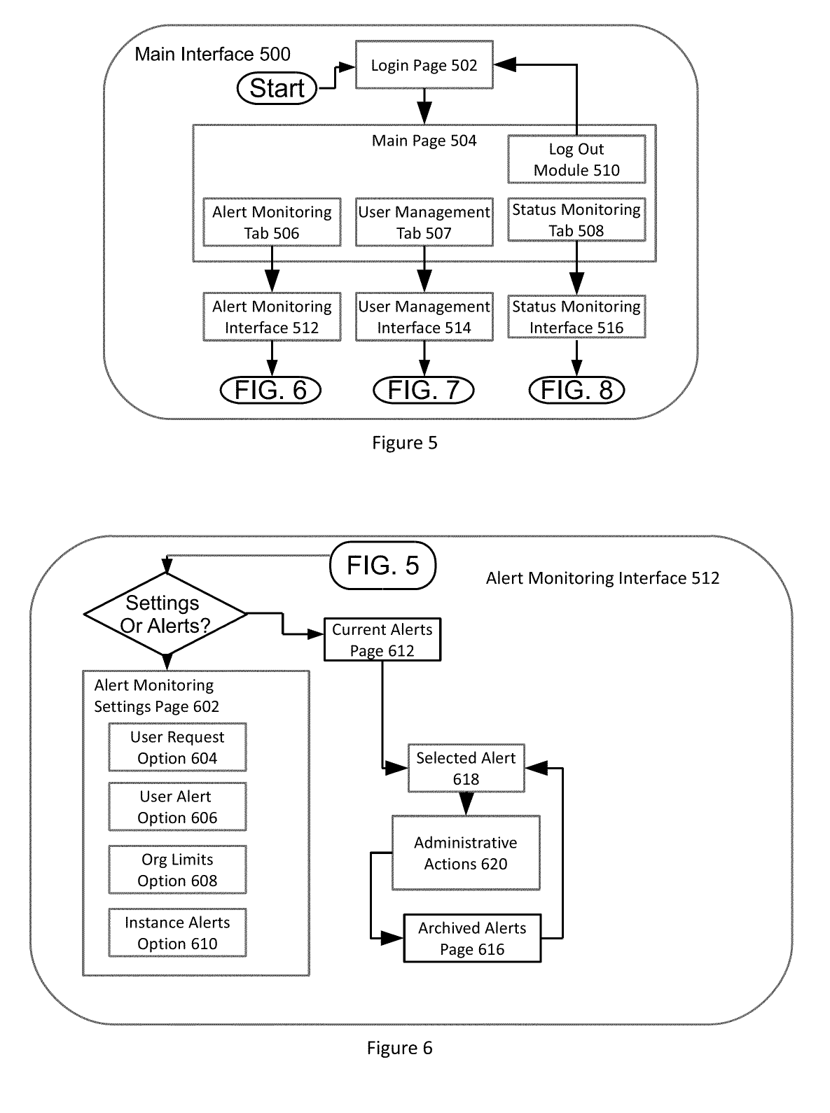

FIGS. 5, 6, 7, and 8 show a flow diagram of an embodiment of a general user interface for a system for mobile multi-tenant database management. FIG. 5 shows a flow diagram of an embodiment of main interface 500 of a system for mobile multi-tenant database management. Login interface 500 includes login page 502, main page 504, alert monitoring tab 506, user management tab 507, status monitoring tab 508, log out module 510, alert monitoring interface 512, user management interface 514, and status monitoring interface 516. In other embodiments login interface 500 may have additional components and/or may not have all components listed above.

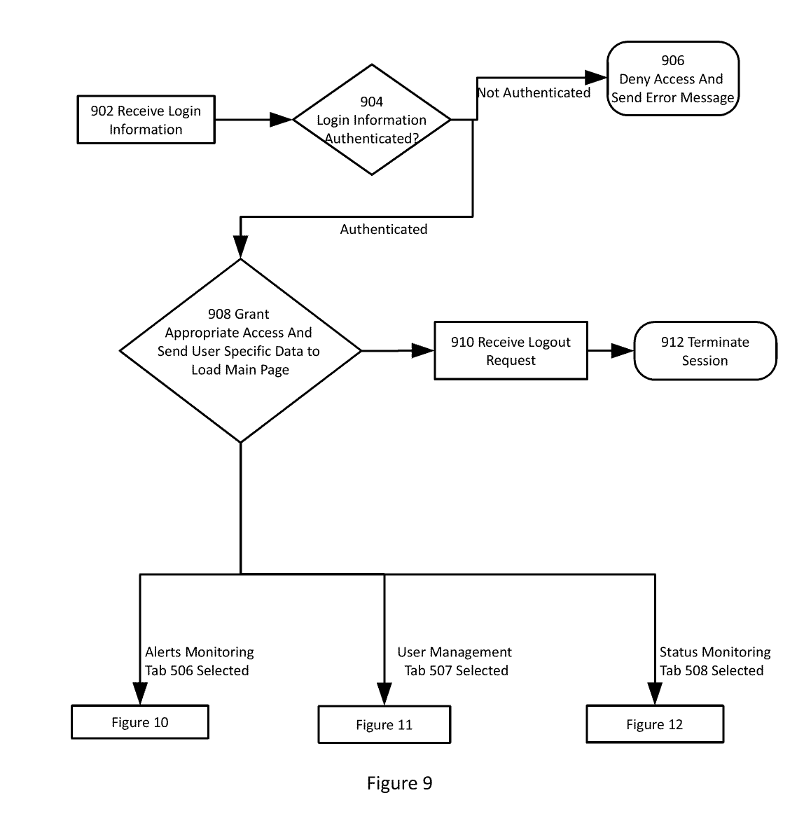

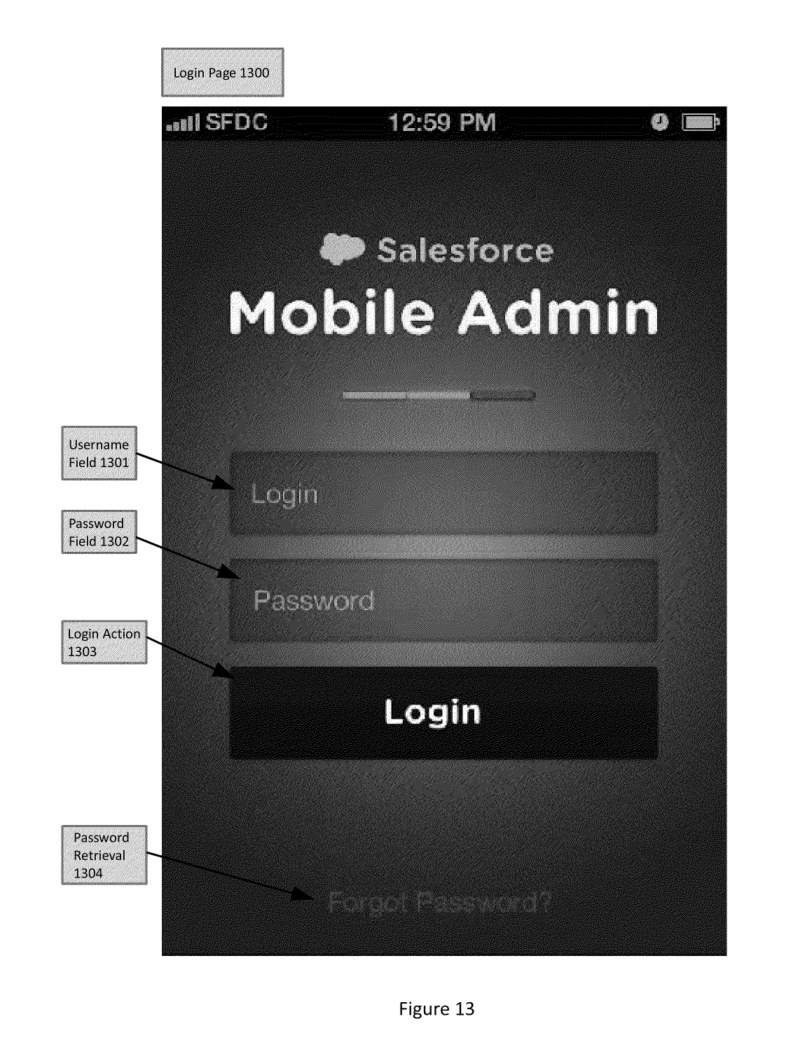

The administrator may input a username and password on the login page 502. Once the username and password are accepted by the application, the system may display main page 504 displaying having an alert monitoring tab 506, a user management tab 507, a status monitoring tab 508, and a log out module 510. Alert monitoring tab 506 displays alert monitoring interface to be displayed. User management tab 507, when selected, causes user management interface to be displayed. Status monitoring tab 508, when selected, causes displays status monitoring interface to be displayed. The tabs may appear as a menu bar at the bottom of main page 504. Main page 504 also includes a log out module 510. The administrator may exit the system by accessing log out module 510 and return to login page 502. Alert monitoring interface 512 is the interface that is displayed when alert monitoring tab 506 is selected. Alert monitoring interface 512 is an interface for viewing alerts and selected alerts to respond to. User management interface 514 is the interface that is displayed when user management tab 507 is selected. Status monitoring interface 516 is the interface that is displayed when status monitoring tab 508 is selected. The login interface will be discussed further, below, in conjunction with FIGS. 9 and 13.

FIG. 6 shows a flow diagram of an embodiment of alert monitoring interface 512. In an embodiment, alert monitoring interface 512 includes alert monitoring settings page 602, user request option 604, user alert option 606, org limits option 608, instance alerts option 610, current alerts page 612, archived alerts page 616, selected alert 618, and administrative actions 620. In other embodiments alert monitoring interface 512 may have additional components and/or may not have all components listed above.

The administrator may access alert monitoring interface 512 by selecting alert monitoring tab 506 (as described in FIG. 5). The administrator may use alert monitoring interface 512 to customize the types of alerts the administrator wishes to receive through the system through alert monitoring settings page 602. User request option 604 controls what user request alerts may be received. For example, the administrator may select to receive requests to reset passwords, deactivate an account, edit a user, and requests to access an application. In other embodiments, user request option 604 may have additional alerts and/or may not have all alerts listed. User alert option 606 controls what user alerts may be received. For example, using user alert option 606, the administrator may select to receive alerts of suspicious behavior and alerts that related to tracking a particular user. Org limits option 608 controls what org limits alerts may be received. For example, the administrator may choose to receive alerts that relate to schema usage, API usage, business logic usage, user interface usage, and licenses. Instance alerts option 610 controls what instance alerts may be received. Instance alerts are alerts that relate to specific instances of the multitenant database. Some examples of instance alerts are datacenter alerts, organization alerts, instance outage, instance slowage, root cause analysis, and instances restored. Datacenter alerts are alerts that are specific to or relate to specific datacenters. Organization alerts are alerts that are specific to or relate to specific organizations. Instance outages are alerts that relate to a specific instance being shutting off or crashing, for example. Instance slowages are alerts that relate to an instance performing at a particularly slow rate. Root cause analysis are alerts that relate to determining the root cause of a problem. Instances restored are alerts that relate to a particular instance of the multitenant database being restarted or otherwise being restored to a proper working state. In other embodiments, instance alerts option 610 may have additional alerts and/or may not have all alerts listed. The alerts that appear on current alerts page 612 may be affected by which alert options the administrator selects.

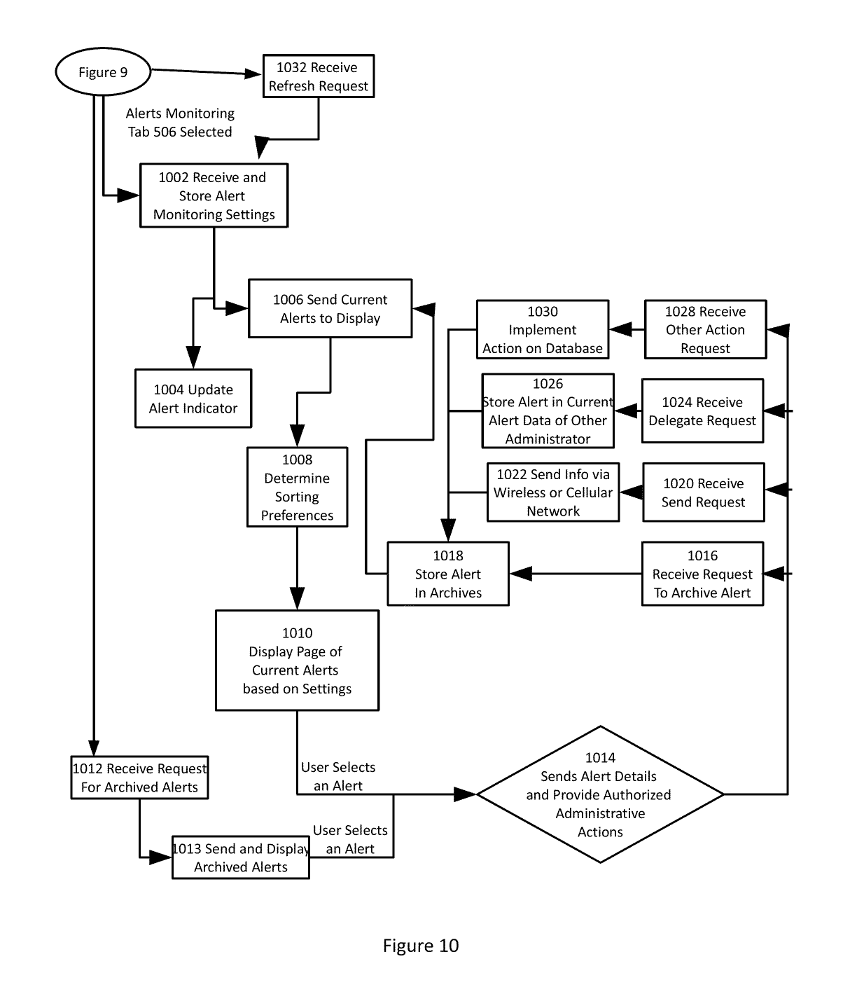

The administrator may review the list of current alerts by selecting the current alerts page 612. The administrator may review a list of archived alerts by selecting the archived alerts page 616. From each respective page, the administrator may review the details of a particular alert by opening and expanding selected alert 618 to display more information and/or the ability to take an administrative action. Depending on the type of alert, selected alert 618 may display various available administrative actions 620. Available actions 620 may provide links to initiate different actions that are available to the administrator. For example, available actions 620 may include different actions, such as archive (for archiving alerts), reset (for resetting an account or password), send (for sending alerts), or delegate (for delegating actions to other users). In other embodiments, available actions 620 may have additional actions and/or may not have all actions listed. Selecting archive directly stores the selected alert 618 in archived alerts page 616 for later action or delegation of the alert. The reset action is an action that may reset a user's account, password, or access to the database. The send action is an action that may send a status update to another administrator, manager, or other user through available reporting mechanisms, such as via email, a post to an internal social network like salesforce.com, inc.'s Chatter®, or other communication. The delegate action is an action that may assign the alert to another administrator, manager, or other user to take the required action. After an administrative action 620 has been taken for a selected alert 618. The selected alert 618 is stored in and can be viewed in archived alerts page 616. Alert monitoring was discussed, above, in conjunction with FIGS. 1 and 2, and will be discussed, further below, in conjunction of FIGS. 10, and 14-24.

FIG. 7 shows a flow diagram of an embodiment of user management interface 514. User management interface 514 includes user directory 702, user search field 704, add user module 706, user information fields 708, edit user 710, user information page 712, administrative actions 714, back button 716, user status 718, activity log 720, reset 722, deactivate 724, user access control 726, migrate access 728, increase access 730, granular level access 732, and action confirmation 734. In other embodiments alert monitoring interface 512 may have additional components and/or may not have all components listed above.

The administrator may access user management interface 514 by selecting user management tab 507 (as described in FIG. 5). The administrator may use the user management interface 514 to manage and configure users who have access to the multi-tenant database system. By selecting user management interface 514, the application displays a page displaying user directory 702 composed of a list of users on the database. The administrator can use user directory 702 to navigate to respective user profiles or accounts. By selecting a particular user in user directory 702, the administrator can view user information page 712. The administrator may also search for a particular user by typing in the user's name in user search field 704 and then select a user among the search results in the user directory to view that user's user information page 712. User information page 712 displays additional details of a user, such as contact information, job title, phone, email, and other information. User information page 712 may also display the current user status 718 of the user within the database, such as that the user has been locked out. User information page 712 may also display the user's activity in activity log 720. Activity log may include a login history and/or a log of other activities. Other activities may be shown in the user's activity log 720 in other implementations. Selecting back button 716 from user information page 712 may bring the administrator back to user directory 702.

The administrator may add a new user to user directory 702 by using add user module 706. Selecting add user module 706 displays a page with user information fields 708 for the administrator to enter information. The information required for each user may vary according to the administrator's database configuration, but may include the new user's Name, Profile (e.g., link to Chatter profile page or type of pre-configured access profile), Role, Manager, Title, etc. Saving the new user's information in user information fields 708 may bring the administrator to the new user's user information page 712 to show the newly saved user information.

From user information page 712, the administrator may take various administrative actions 714. Here, the administrator can reset, deactivate, or edit the user account by choosing from several action modules such as reset 722, deactivate 724, or edit user 710, respectively. An administrator that chooses edit user 710 may see a page with user information fields 708. Any of the information required for add user module 706 may be edited, or editable information may be limited, depending on the configuration. Editable user information fields 708 may include a user's access Profile, Role, Manager, and Title. Other editable information may also be available. Saving the user's edited information in user information fields 708 may bring the administrator to the edited user's user information page 712 to show the edited user information.

Other administrative actions 714 may also be made available. For example, migrate access 728 and increase access 730 can be used by an administrator with privileges over multiple organizations and/or instances to migrate or increase user access, respectively, to different organizations and/or instances. There may also be an option for granular level access 732. For example, the administrator may be able to configure user access to only certain data depending upon the user's location as indicated by the user's mobile device or computer. If the user is at a work office, he may access more data than if the user is at a customer site. Other activities may also be made available.

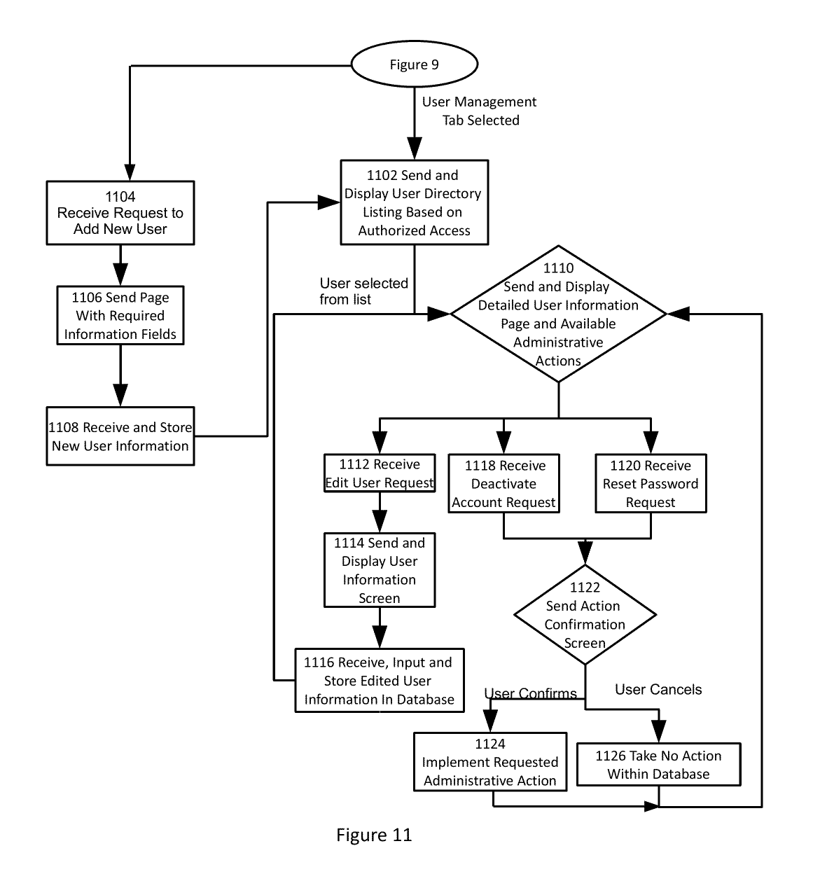

Each administrative action 714 taken by the administrator may require an action confirmation 734, since the actions of administrative action 714 can affect user access. Action confirmation 734 brings up a screen that gives the administrator the option to confirm or cancel the action. Once an administrative action 714 has been confirmed, the administrator is returned to user directory 702. User Management was also discussed above in conjunction with FIGS. 3, and will be discussed further in conjunction with FIGS. 11 and 25-29.

FIG. 8 shows a flow diagram of an embodiment of a general user interface for a status monitoring interface 516. Status monitoring interface 516 includes datacenter status 802, organization status 804, organization status 806, datacenter status 808, monitoring details 810, organization monitoring details 812, indicators 814, additional details 816, reporting mechanism 817, datacenter monitoring details 818, login 820, search 822, mobile 824, API 826, email to lead 828, email to case 830, web to lead 832, and web to case 834. In other embodiments status monitoring interface 516 may have additional components and/or may not have all components listed above.

The administrator may access status monitoring interface 516 by selecting status monitoring tab 508 (as described in FIG. 5). The administrator may use status monitoring interface 516 to monitor the status of an instance, a datacenter, a server, etc, including detailed information on the status. Status monitoring interface 516 displays a page with datacenter status 802 of a particular datacenter, as well as organization status 804 and organization status 806 of different organizations within the particular datacenter. Various visual indicators can be used to readily identify if there are any issues, such as a green checkmarked circle to indicate a positive status, and a red exclamation point in a circle to indicate an issue that requires further attention. Depending on the datacenter, there may be more or less organizations within the datacenter. Depending on the access of the administrator, there may be datacenter statuses, such as datacenter status 808, for one or more other datacenters with one or more organization statuses for organizations within each datacenter.

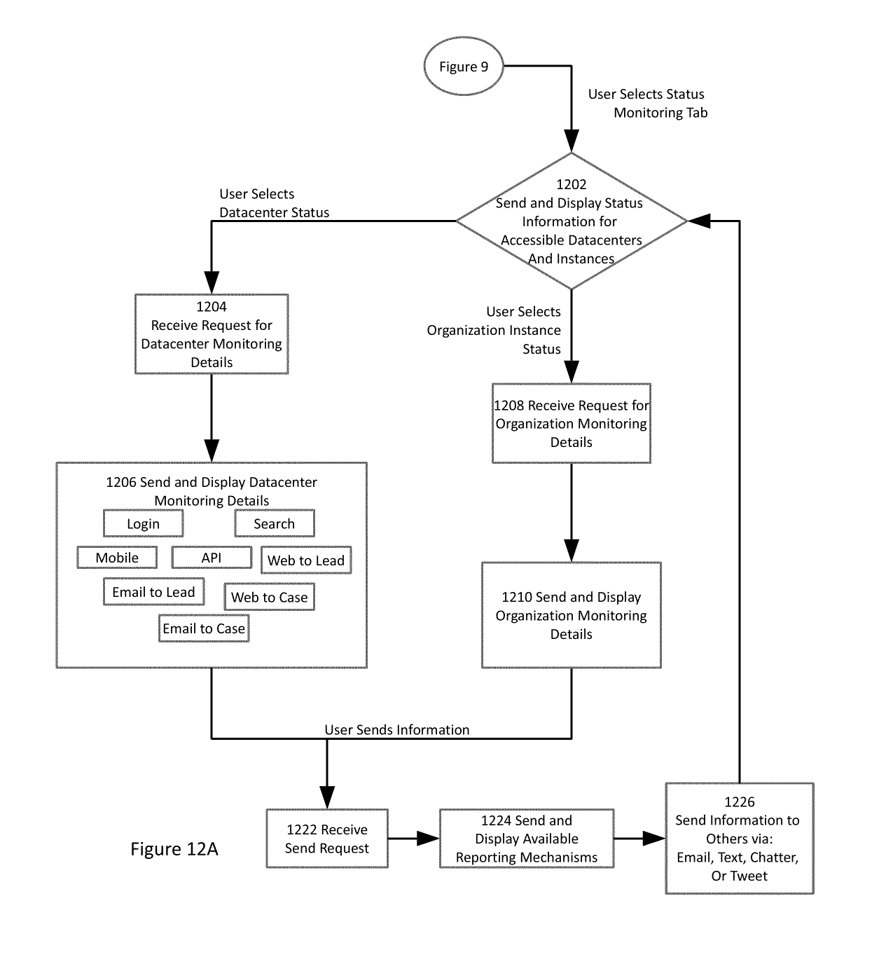

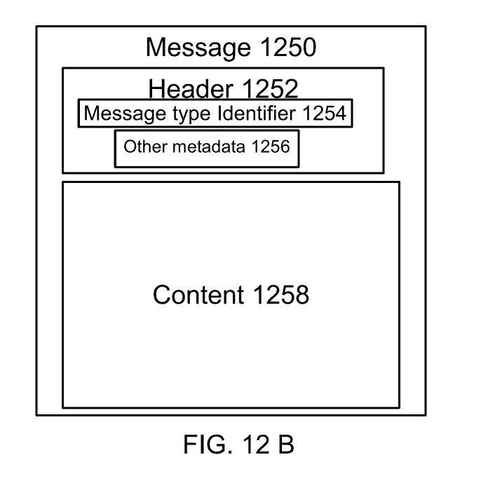

The page displayed by status monitoring interface 516 also includes monitoring details 810. Monitoring details 810 is a section of status monitoring interface 516 that displays additional details of the selected instance. Selecting datacenter status 802 may display additional datacenter monitoring details 818 for that particular datacenter within monitoring details 810. Selecting datacenter status 808 may display datacenter monitoring details 818 for that particular datacenter instance in datacenter monitoring details 810. For a datacenter instance, the administrator can view datacenter monitoring details 818, such as the statuses for login 820, search 822, mobile 824, API 826, email to lead 828, email to case 830, web to lead 832, and web to case 834. Optionally, green check marked circles may indicate a positive status and a red exclamation point in a circle to indicate an issue that requires further attention. Other information may also be available per the administrator's configuration or needs. Monitoring details 810 may also display organization monitoring details 812 where an organization status, such as organization status 804 or organization status 806, is selected. Organization monitoring details may include the number of user requests per day, but other information may also be available for display. Indicators 814 are specific points or events that the administrator can “drill-down” or explore additional details 816 of certain events. Monitoring details 810 may also include a reporting mechanism 817 that enables the administrator to transmit status information within monitoring details 810 to others via email, text message, posting to Chatter, posting to Twitter, or other communication. Status monitoring was also be discussed, above, in conjunction with FIG. 4, and will also be discussed further, below, in conjunction with FIGS. 12 and 30-34

FIGS. 9-12 show operational flow diagrams illustrating a server-side method of managing a multi-tenant database system on a mobile device. The server system contains a processor system and a memory system. The server system may communicate with the mobile application through wireless internet or some other cellular data network. The server system includes a memory system and a processor system.

FIG. 9 shows the first part of a flowchart of an embodiment of a server-side method 900 of logging in to a mobile application for managing a multi-tenant database system, and shows how the server system logs in or out an administrator and displays the main page. In step 902, login information is received from the administrator consisting of a username and/or password. In step 904, the login information is authenticated by the server system. In step 906, where an incorrect username or password is received, the server may deny access and send error message. In step 908, where the username and password is authenticated, the server may grant the appropriate access assigned to the administrator and send user specific data to load the main page to display main interface 500. Depending on which tab (alerts monitoring tab 506, user management tab 507, status monitoring tab 508) is selected by the administrator, the server may send the appropriate information and page to the mobile application based on the administrators access (see FIGS. 10-12 below). In step 910, the server receives a log out request. In step 912, the server terminates the administrator's session. In other embodiments, method 900 may not have all of the above steps and/or may have other steps in addition to, or instead of, those listed above. The steps of method 900 may be performed in another order. Subsets of the steps listed above as part of method 900 may be used to form their own method. The login interface was also discussed previously in conjunction with FIG. 5, and will be discussed further, below, in conjunction with FIG. 13.

FIG. 10 shows the second part of a flowchart of an embodiment of a server-side method 1000 of monitoring alerts for a multi-tenant database system on a mobile device, and shows how the server system sends alerts to the mobile application and receives administrative actions from the administrator. In step 1002, the server system receives and stores alert monitoring settings selected by the administrator in alert configuration settings system 200. In step 1004, the server system updates the mobile application's alert indicator 120 based on the alert monitoring settings selected by the administrator and received in step 1002. In step 1006, the server system sends current alerts to display to the administrator. The current alerts are sent based on the alert monitoring settings selected by the administrator and received in step 1002. In step 1008, the server system determines any existing sorting preferences for displaying the current alerts. Sorting preferences may be chosen by the administrator or be default preferences. In step 1010, the server system displays page of current alerts based on alert monitoring settings and sorting preferences. From the page of current alerts, the administrator may select an alert, or to see the archived alerts list. In step 1032, the server system receives a refresh request which may run steps 1002-1010 to update the page of current alerts and the alert indicator.

In step 1012, the server system receives a request for archived alerts. In step 1013, the server system sends and displays a page of archived alerts. The display of archived alerts may be listed with predetermined or default sorting preferences. In step 1014, the server system sends and displays alert details along with available administrative actions. The alert details and available administrative actions are sent and displayed when the administrator selects an alert either from the page of current alerts from step 1010, or from the page of archived alerts from step 1013. The administrator may choose to archive the alert or take one of the available administrative actions. In step 1016, the server system receives request to archive alert. In step 1018, the server system stores the alert as an archived alert for the administrator's particular user data.

In step 1020, the server system receives a send request for an alert. In step 1022 the server system sends the information via wireless or cellular network. In step 1024, the server system receives a delegate request for an alert to be assigned to another administrator on the server system. In step 1026, the server system stores the alert from step 1024 in the current alert data of another administrator on the system. In step 1028, the server system receives a request for some other administrative action to be taken, including reset password and deactivate account. In other implementations there may be other available administrative actions. In step 1030, the server system implements the requested action from step 1028 on the database. After each of steps 1022, 1026, or 1030, the server system may initiate step 1018 to store the alert as an archived alert for the administrator's particular user data. After the alert has been archived in step 1018, the server system returns to step 1006 to send current alerts to display which may no longer include the archived alert.

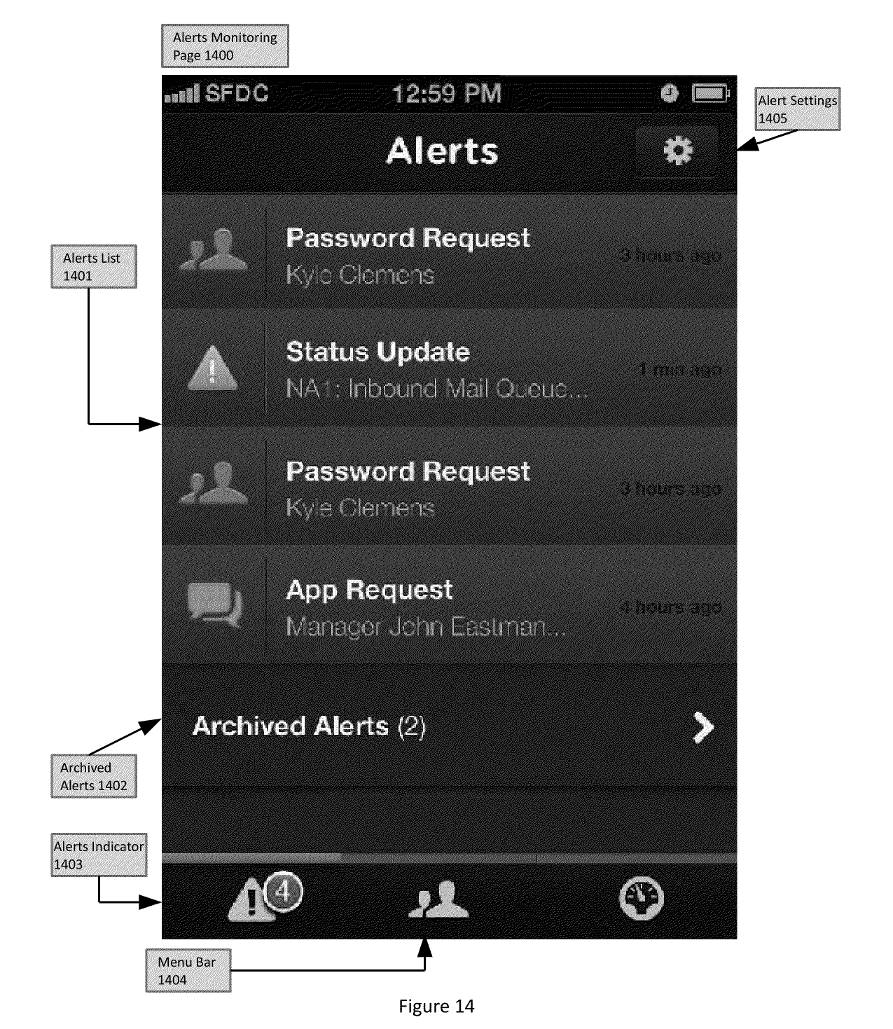

In other embodiments, method 1000 may not have all of the above steps and/or may have other steps in addition to, or instead of, those listed above. The steps of method 1000 may be performed in another order. Subsets of the steps listed above as part of method 1000 may be used to form their own method. Alert monitoring was discussed, above, in conjunction with FIGS. 1, 2 and 6, and will be discussed further, below, in conjunction of FIGS. 14-24.

FIG. 11 shows the third part of a flowchart of an embodiment of a server-side method 1100 of managing users on a multi-tenant database system on a mobile device. In step 1102, the server system responds to the administrator's selection of the user management tab 507 and sends and displays a user directory 702 based on the administrator's authorized access. In step 1104, the server system receives a request to add new user to the database. In step 1106, the server system sends a page with the required user information fields 708. In step 1108, the server system receives and stores the new user information in the database and returns to step 1102 to send and display user directory listing, including the newly added user.

In step 1110, the server system responds to an administrator's selection of a particular user from user directory 702 and displays detailed user information page 712, including user information, user status, activity log, and available administrative actions. One of the actions an administrator may choose is to edit user 710. In step 1112, the server system receives the edit user request. In step 1114, the server system sends and displays a page with the user information fields 708. In step 1116, the server system receives and stores the edited user information in the database and returns to step 1110 to send and display detailed user information page 712. Other available administrative actions provided in step 1110 may include deactivating a user's account or resetting a user's password. In step 1118, the server system receives a deactivate account request. In step 1120, the server system receives a reset password request. In step 1122, the server system sends an action confirmation screen 734 in response to either step 1118 or step 1120. At this point the administrator may confirm or cancel the selected action. In step 1124, where the administrator confirms the selected action, the server system implements the requested administrative action within the database system. In step 1126, where the administrator cancels the selected action, the server system takes no action within the database system. After either step 1124 or 1126, the server system returns to step 1110 to send and display detailed user information page 712.

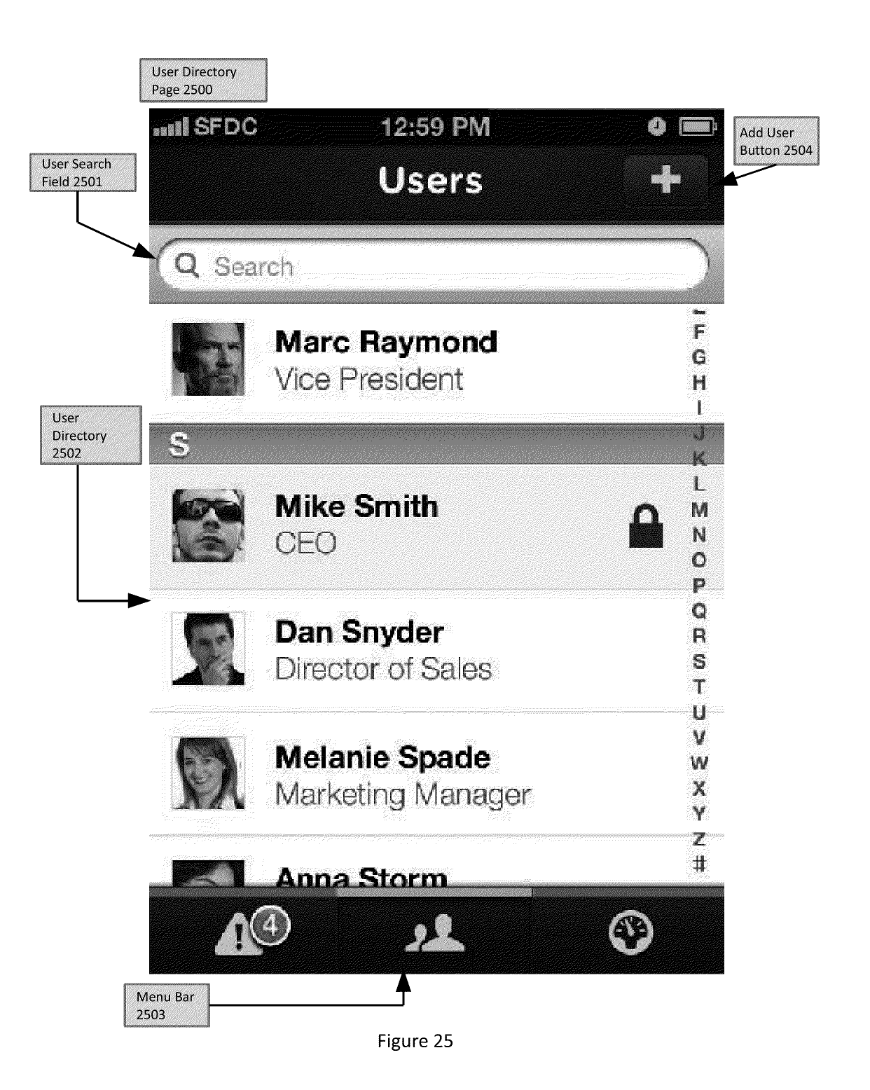

In other embodiments, method 1100 may not have all of the above steps and/or may have other steps in addition to, or instead of, those listed above. The steps of method 1100 may be performed in another order. Subsets of the steps listed above as part of method 1100 may be used to form their own method. User management was also discussed above in conjunction with FIGS. 3 and 7, and will be discussed further in conjunction with FIGS. 25-29.

FIG. 12A shows the fourth part of a flowchart of an embodiment of a server-side method 1200 of monitoring datacenter and instance statuses in a multi-tenant database system on a mobile device. In step 1202, the server system responds to the administrator's selection of status monitoring tab 508 and sends and displays status information for accessible datacenters and instances, such as datacenter statuses 802 and 808, and organization statuses 804 and 806.

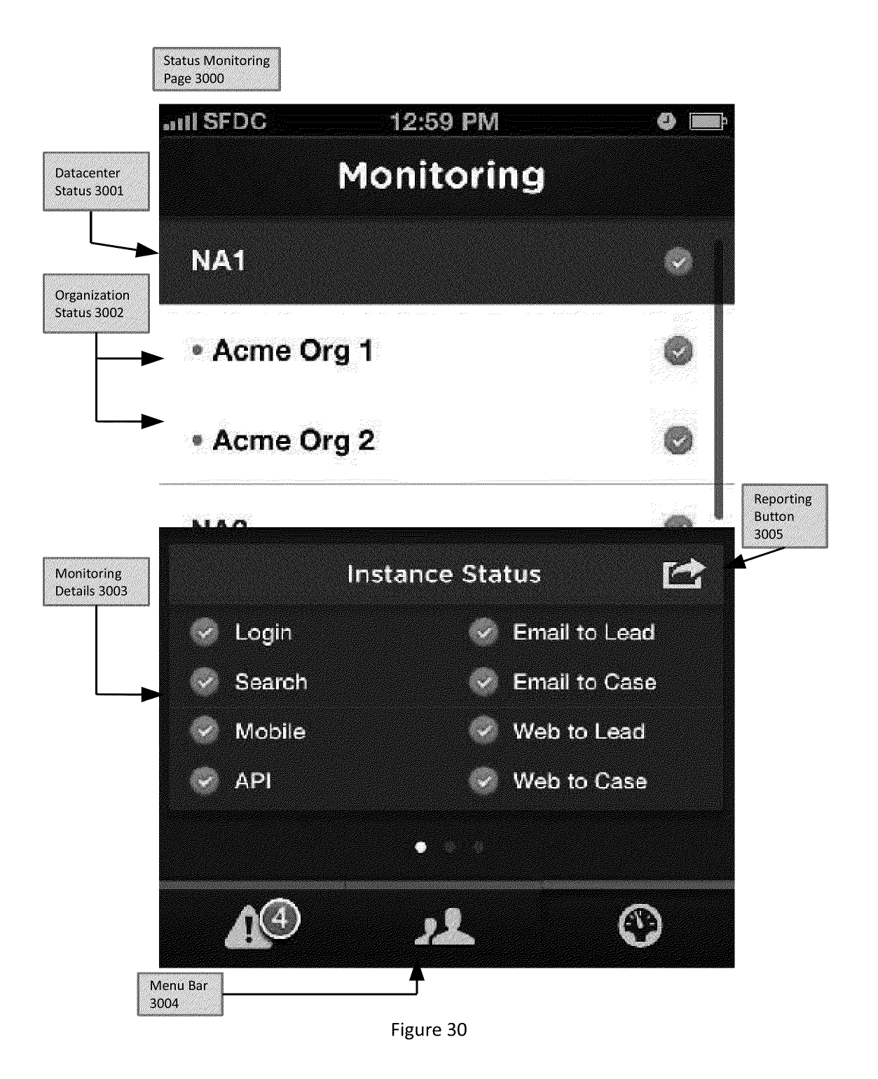

In step 1204, where the administrator selects a particular datacenter status, such as datacenter status 802, the server system receives request for datacenter monitoring details for the selected datacenter. In step 1206, the server system sends and displays datacenter monitoring details 818 to the administrator. Datacenter monitoring details 818 may include login, search, mobile, API, web to lead, email to lead, web to case, and email to case statuses. In other implementations, there may be other statuses available. In step 1208, where the administrator selects an organization status, such as organization status 804, the server system receives request for organization monitoring details. In step 1210, the server system sends and displays organization monitoring details 812 to the administrator. In step 1222, where administrator selects reporting mechanism 817, the server system receives request to send the datacenter or organization details. In step 1224, the server system sends and displays available reporting mechanisms to the administrator. In step 1226, the server system sends the information via email, text message, posting to Chatter, posting to Twitter, or other available reporting mechanism. The server system then returns to step 1202 to send and display status information for accessible datacenters and instances. Status monitoring was also discussed, above, in conjunction with FIGS. 4 and 8, and will also be discussed further, below, in conjunction with FIGS. 30-34

FIG. 12B is a block diagram of an embodiment of a message 1250. Message 1250 include message header 1252, message type identifier 1254, other metadata 1256, and content 1258. In other embodiments, message 1250 may have other elements in addition to and/or instead of those shown in FIG. 12B.

Message 1250 is a messages sent by the application running on the user's mobile device to a server or sent from the server being managed to the user's mobile device. The incoming and outgoing messages 1250 sent to the user mobile device have a special format. The incoming messages 1250 have a special format so that the user mobile device can detect that the message relates to the application, and associates the incoming message with the application. The outgoing messages 1250 have a special format so that the multitenant database properly classifies and process the incoming messages. For example, the messages that include a corrective action to take, the action that needs to be taken needs to be identified.

Header 1252 includes any header information sent along with message 1250, which may include metadata sent as part of any standard message sent across a particular network. Message type identifier 1254 identifies the type of the message being sent. In an embodiment, the message may have one or more message type identifiers 1254 associating the messages with the application on the user mobile device and/or may have one or more message type identifiers 1254 that the user system uses to categorize the type of message. Message type identifiers 1254 may indicate whether the messages to the user mobile device indicate the statuses of instances and organization or are alerts. Message type identifiers 1254 may also identify the type of alert and or the type of status update. In the messages to the multitenant database, message type identifiers 1254 may identify whether the message is a request for information or a request to perform an action. Additionally, message type identifiers 1254 may identify the type of information requested and/or the type of action requested. In an embodiment, message type identifiers 1254 are located in metadata sent in the header of the message. In another embodiment the type of message may be indicated in the body of the message in addition to and/or instead of in the metadata in the header.

Other metadata 1256 may include any other metadata include in the message 1250, such as routing information. Content 1258 is the actual content of the message. The application is also cable of sending messages to the multitenant database, which are processed by the multitenant database and address one of the issues identified by a an alert or other message. In an embodiment, alerts are sent to the user mobile device, periodically, or as the alerts occur. The messages sent from the multitenant database may be sent to multiple users that collectively manage the multitenant database. In an embodiment, the archive of the alerts is stored at the multitenant database. In another embodiment, the archive of the alerts is stored at the user mobile device in addition to or instead of being stored at the multi-tenant database. In an embodiment, the information being sent to the user device, the application on the user device, and the actions that the administrator can take pertain to the system as a whole, and the administrator can use the application to manage the multi-tenant database. In another embodiment, the application is given to tenants of the multi-tenant database for administrators of the tenants to manage issues with the portion of the multitenant database that the tenant has access to.

FIG. 13 shows a screenshot of an embodiment of a login page 1300 for the application. Login page 1300 includes username field 1301, password field 1302, login action 1303, and password retrieval 1304. In other embodiments login page 1300 may have additional components and/or may not have all components listed above.

To access the system, the administrator inputs the assigned username into username field 1301 and the assigned password into password field 1302. Login action 1303 sends the username and password information to the server for confirmation and access to the system. In other embodiments, the username and password information may be confirmed by the program running on the mobile device. In the case of a lost password, password retrieval 1304 sends the administrator's password information to the administrator via text message, email, or some other predetermined mode of messaging.

In an implementation, the person logging in may receive access to some or all of the features disclosed herein, depending up on the privileges that the user has, or the number of features that the system may be configured to expose. For purposes of the figures, the user logging in is an administrator who manages one or more tenants in the Salesforce multi-tenant database system. The administrator has access to all of the features shown and discussed herein. Additional database management features beyond those shown in the figures may also be accessible. The login interface was also discussed, previously, in conjunction with FIGS. 5 and 9.

FIGS. 14-24 discuss alert monitoring, among other things, which was also discussed, above, in conjunction with FIGS. 1, 2, 6 and 10. FIG. 14 through FIG. 18 show a screenshot of an embodiment of an alerts monitoring page 1400. Alerts monitoring page 1400 includes alerts list 1401, archived alerts 1402, alerts indicator 1403, menu bar 1404, and alerts settings 1405. In other embodiments alerts monitoring page 1400 may have additional components and/or may not have all components listed above.

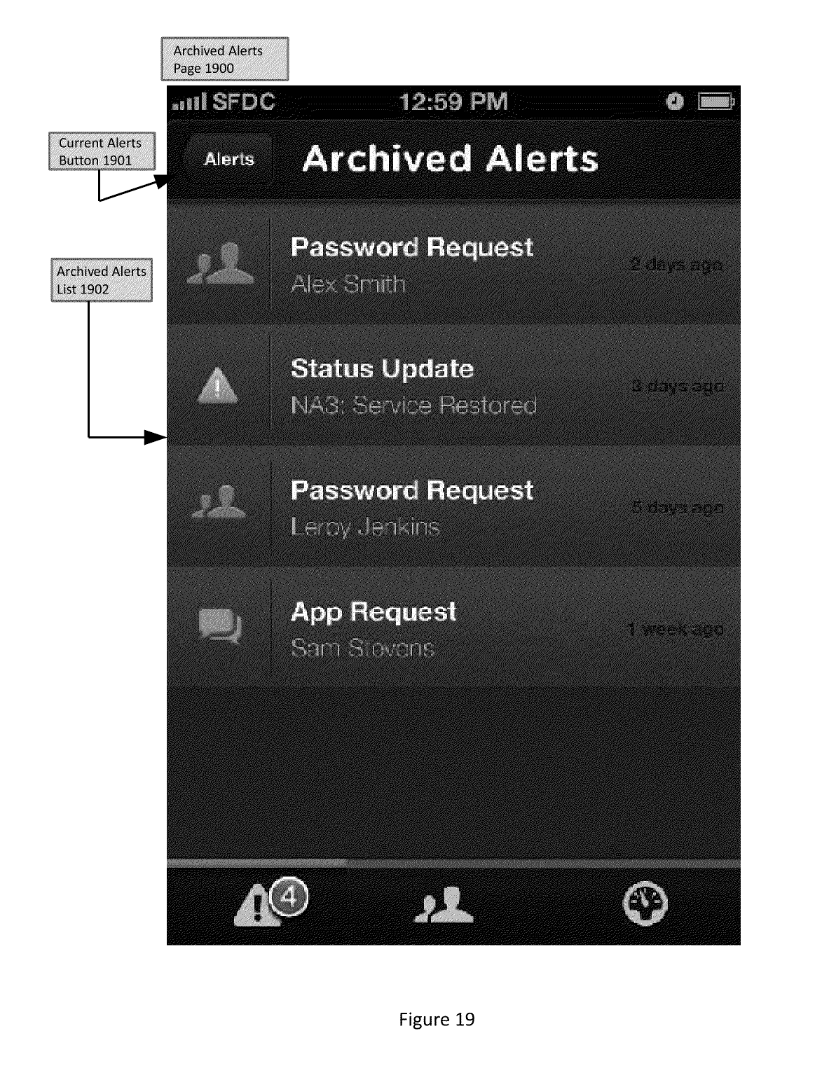

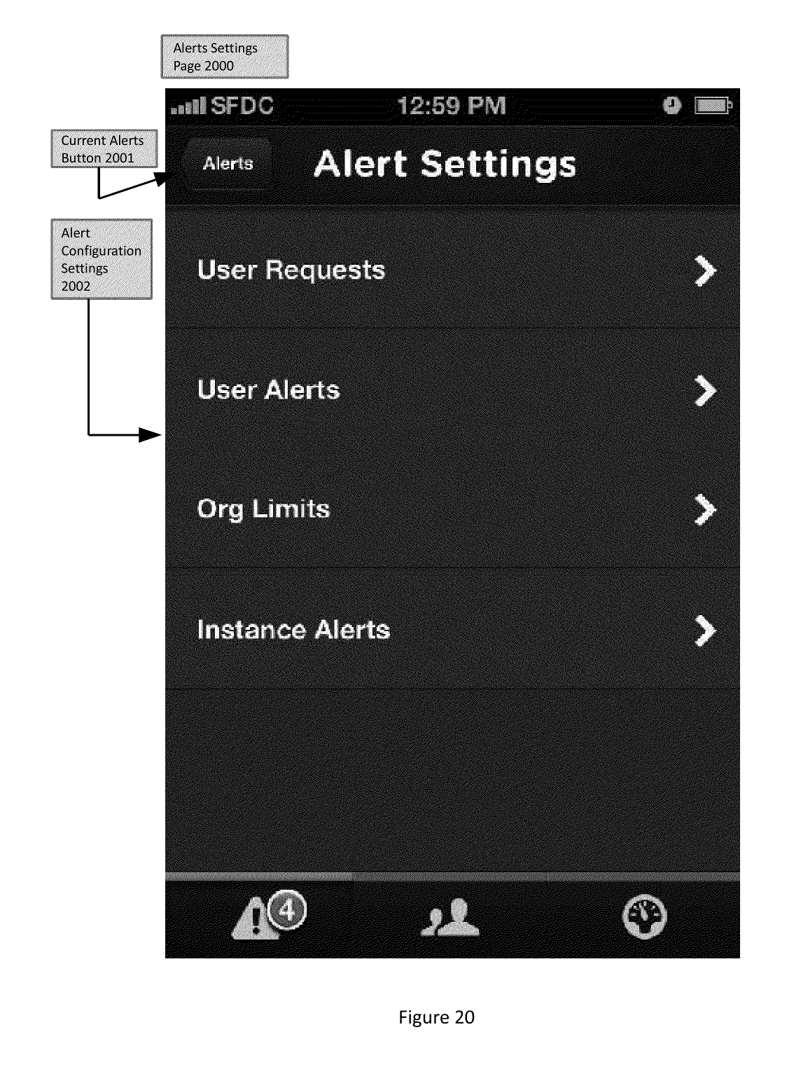

The administrator can monitor and review outstanding alerts from the alerts monitoring page 1400. As shown in FIG. 14, in an embodiment, there are four alerts visible to the administrator on the alerts list 1401: password request, status update, and app request. Also shown are the times when the alerts were received. Alerts can be sorted chronologically, by priority, or by another order. Alerts indicator 1403 on the bottom menu bar 1404 shows the number of alerts. An administrator may also receive an alert using the mobile device's built-in notification system, through email, text message, and/or other communication. Archived alerts access the alert settings page (archived alert will be discussed further in conjunction with FIG. 19). Selecting other tabs on menu bar 1404 may retrieve other pages, such as user management page (shown at FIG. 25) and status monitoring page (shown at FIG. 30). As shown, a colored bar above the selected tab indicates, which tab has been selected. Password requests, status updates, and app requests are not the only alerts that may appear to the logged-in administrator. Alerts can also be filtered such that only certain ones may be shown. Alerts settings 1405 on the top right of alerts monitoring page 1400 takes the administrator to alerts settings page (shown at FIG. 20) for the customization and filtering of which alerts to receive.

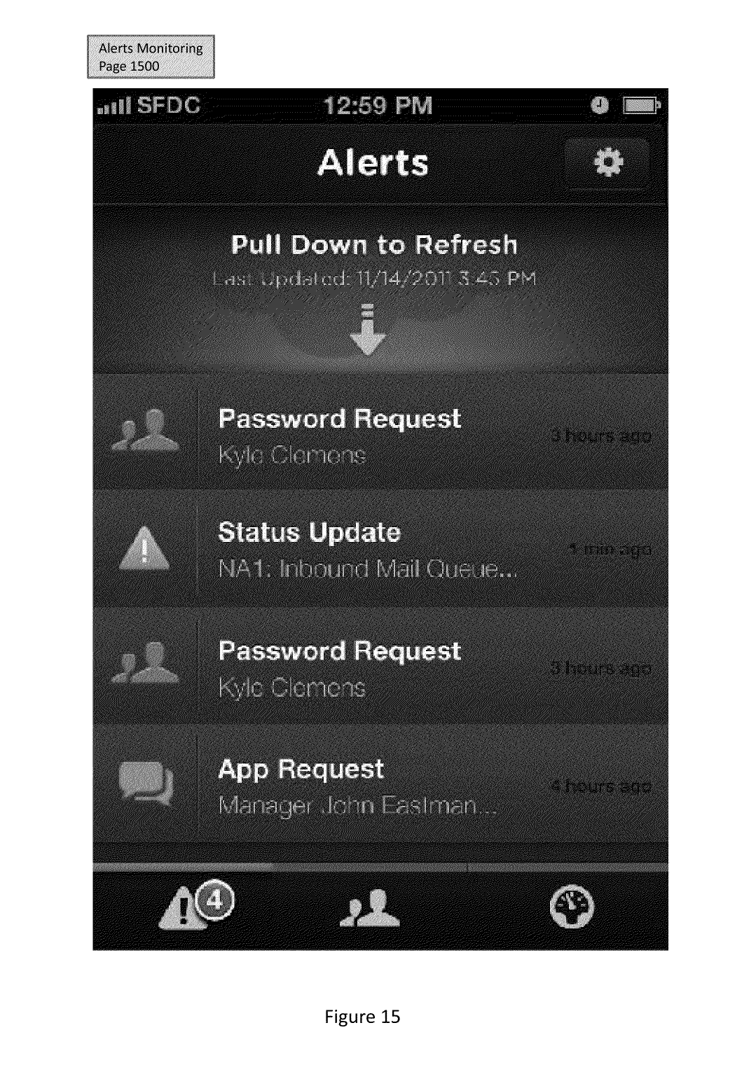

FIG. 15 shows a screenshot of an embodiment of another view of an alerts monitoring page 1500. Alerts monitoring page 1500 is the same as alerts monitoring page 1400, except alerts monitoring page 1500 shows how the alerts list 1401 can be refreshed. Other options may include another gesture, or a dedicated button. Optionally, may automatically refresh or be displayed in real-time or near real-time.

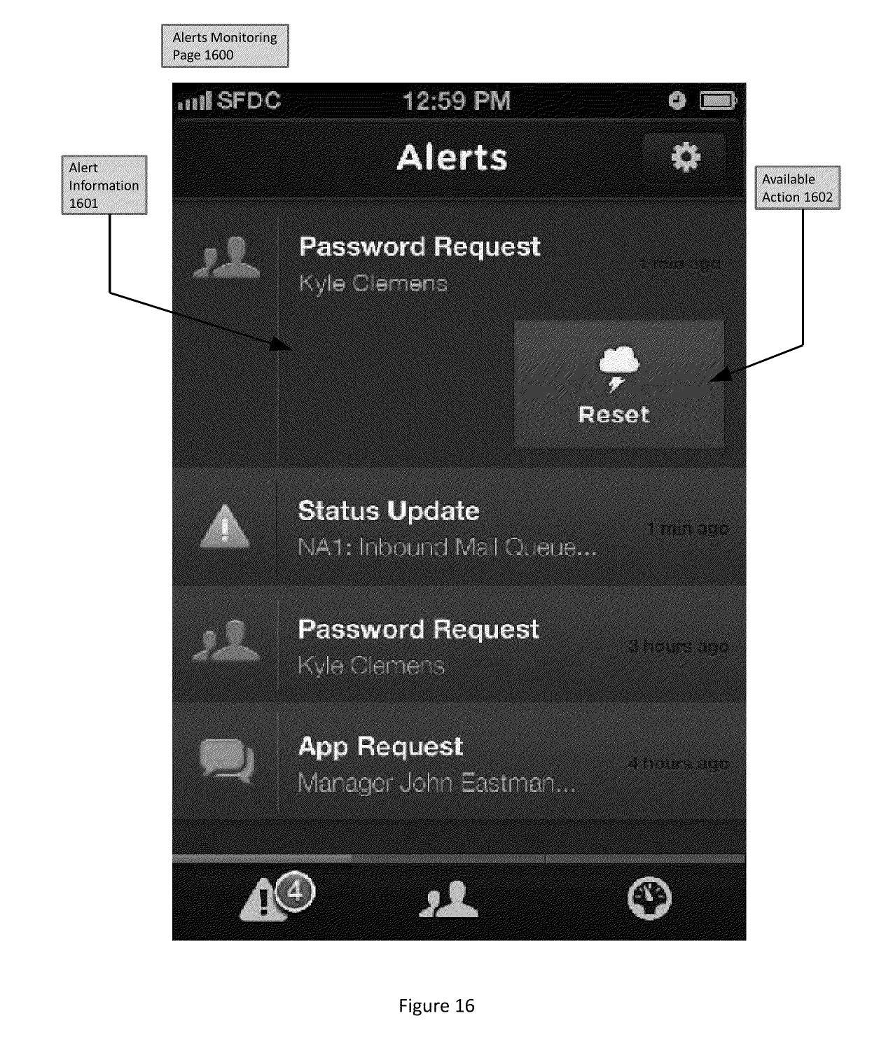

FIG. 16 shows a screenshot of an embodiment of a password request action on an alerts monitoring page 1512. Alerts monitoring page 1512 is the same as alerts monitoring page 1400, except alerts monitoring page 1512 shows that selecting one of the alerts from alert list 1401 may expand the alert to provide alert information 1601 and/or the ability to take an available action 1602. Here, the administrator may reset Kyle Clemens' password in response to his request. Other options may also be available (e.g., contact user, delete user account, update user account, etc.). Options may be presented, via a gesture, dropdown menu, and/or other display techniques. Once an action is taken, the alert may disappear from the alerts screen, and/or may be archived should the administrator wish to access the alert later.

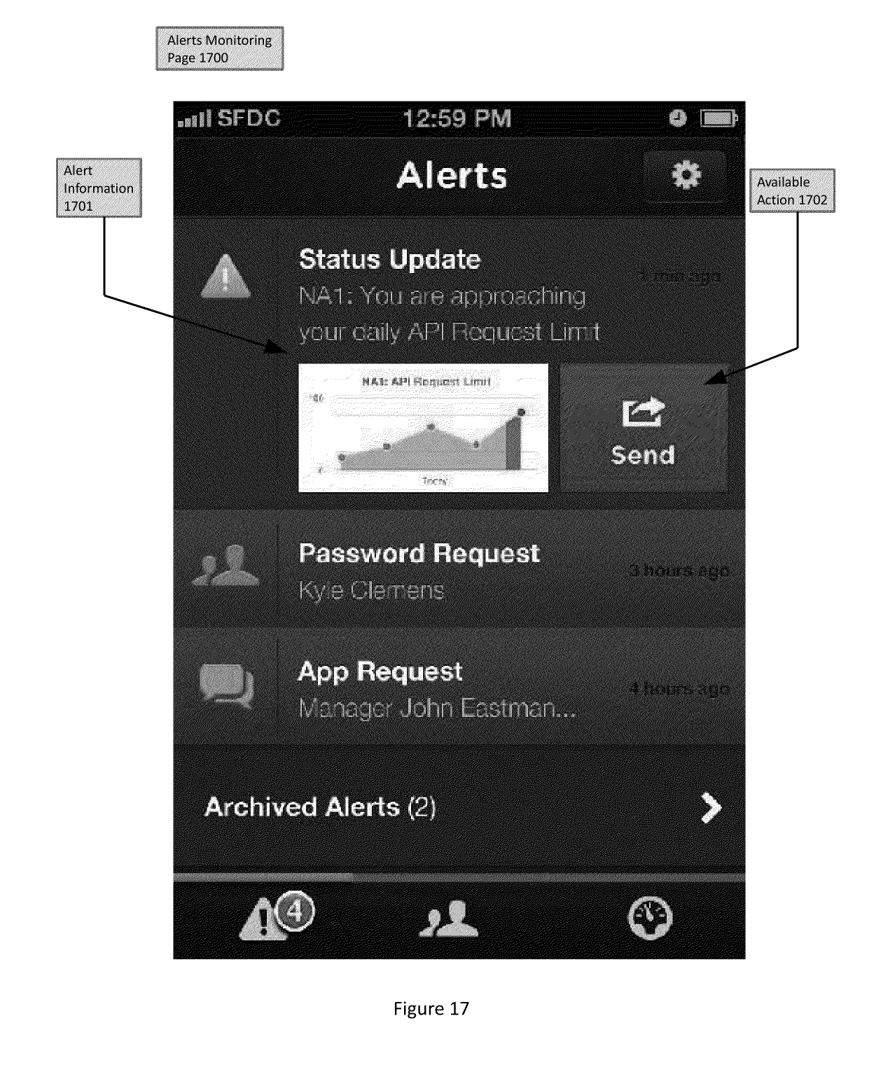

FIG. 17 shows a screenshot of an embodiment of a status update action on an alerts monitoring page 1514. Alerts monitoring page 1514 is the same as alerts monitoring page 1400, except alerts monitoring page 1514 shows the status of the datacenter NA1 in the alert information 1701, because one or more tenants managed by the administrator is approaching a predetermined daily API request limit, which may place a limit of the number of API calls may be made and/or the number of API functions may be called. As an available action 1702, the administrator may send a report of this alert via email, a post to an internal social network like salesforce.com, inc.'s Chatter®, or other communication. In one or more implementations, the application may provide more information on what may be causing the alert. Other remedial or reporting actions may also be available.

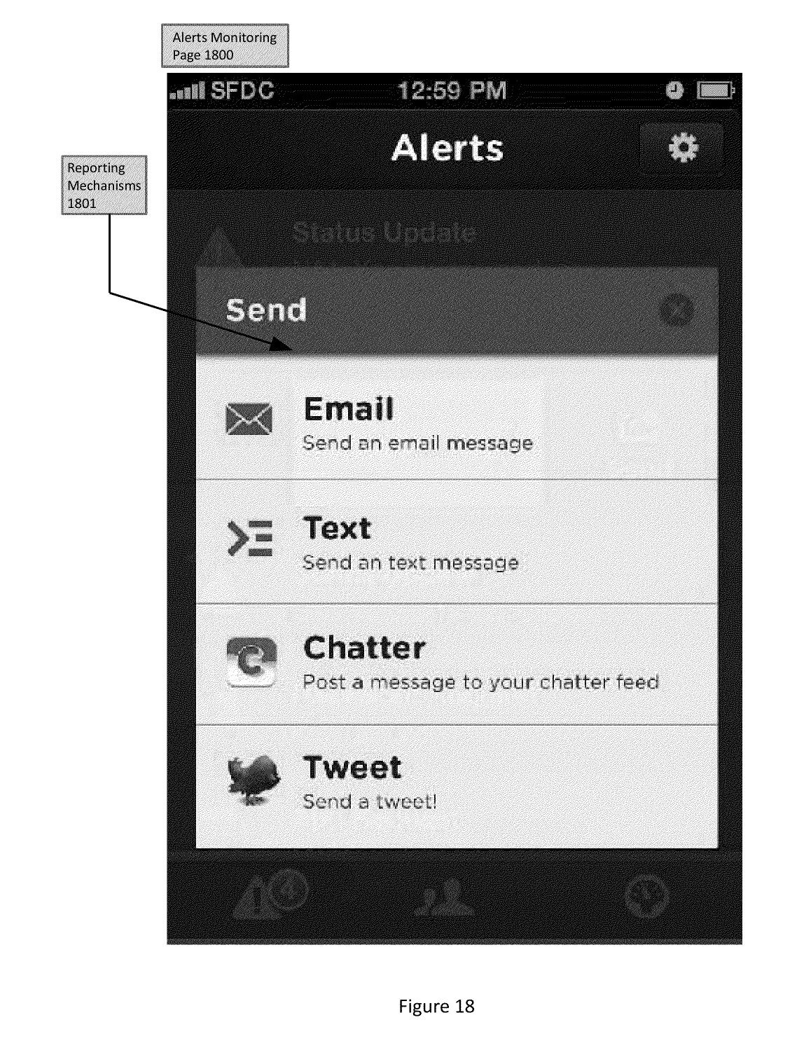

FIG. 18 shows a screenshot of an embodiment of another view of an action on an alerts monitoring page 1516. Alerts monitoring page 1516 is the same as alerts monitoring page 1400, except alert monitoring page 1516 shows reporting mechanisms 1801 with various methods of communication that may be initiated from the application, including but limited to email, text message, posting to a social network, such as Chatter, Twitter, Linkedin, Plaxo, or Facebook.

FIG. 19 shows a screenshot of an embodiment of an archived alerts page 1900. Archived alerts page 1900 includes current alerts button 1901 and archived alerts list 1902. In other embodiments archived alerts page 1900 may have additional components and/or may not have all components listed above.

As mentioned previously, alerts may be archived for access later. FIG. 19 shows the screen of the archived alerts page 1900 with archived alerts shown in archived alerts list 1902. In one or more implementations, alerts may be archived to remind the administrator to take future action, or may serve as a record of past actions taken in response to prior alerts. In other implementations, the times when the alerts were received or archived may be recorded and/or shown. The archived alerts list 1902 may be organized chronologically, by status, by action taken or not taken, by user, or the like. In one or more implementations, alerts or actions may be delegated to other administrators or users with sufficient privileges. Delegating or otherwise transmitting alerts may use a different screen and/or process than those shown herein. Selecting current alerts button 1901 brings the administrator back to alerts monitoring page 1400.

FIG. 20-FIG. 24 show screenshots of an embodiment of an alerts settings page 2000 and embodiments of alert configuration pages for the various types of alerts. Alerts settings page 2000 includes current alerts button 2001 and alert configuration settings 2002. In other embodiments alerts settings page 2000 may have additional components and/or may not have all components listed above. Some of the alert configuration settings 2002 available for alerts are shown. Alert configuration settings 2002 may include ser requests, user alerts, org limits, and/or instance alerts. Other alerts are also possible. Alerts settings page 2000 may enable the administrator to customize how the administrator wishes to be notified of certain events. Selecting current alerts button 2001 from the alerts settings page 2000 brings the administrator back to alerts monitoring page 1400.

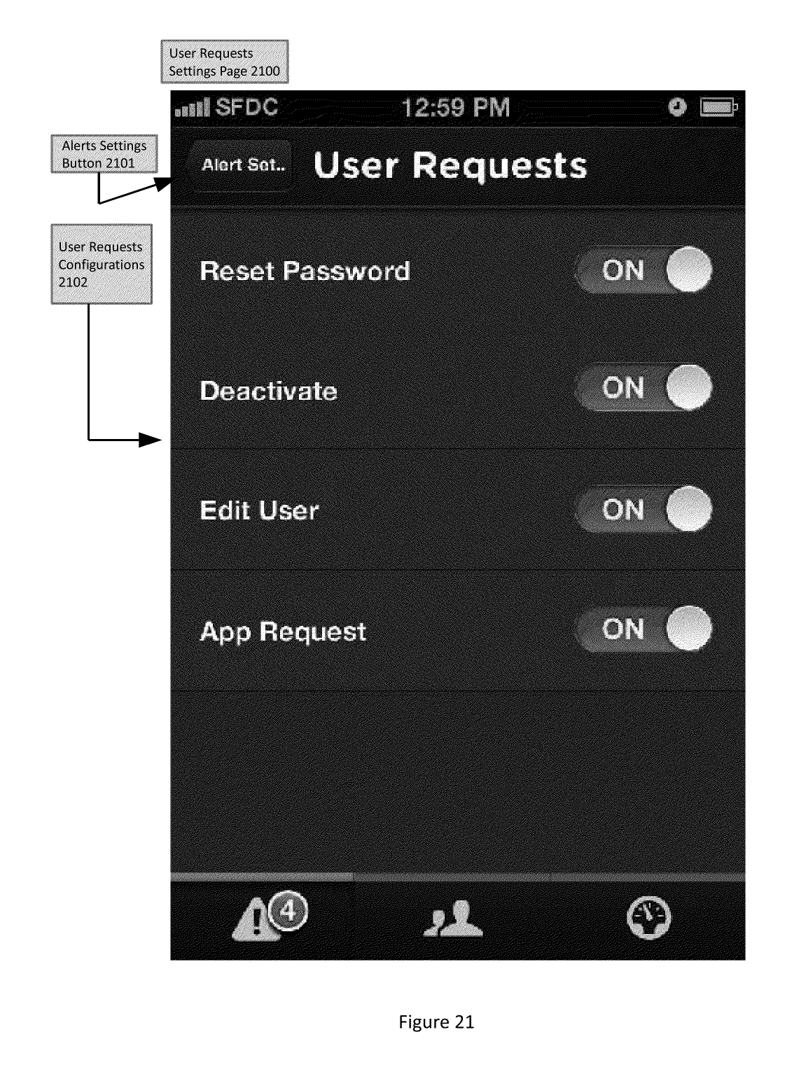

FIG. 21 shows a screenshots of an embodiment of a user requests settings page 2100. In an embodiment, user requests settings 2100 includes alerts settings button 2101 and user requests configurations 2102. In other embodiments, user requests settings page 2100 may have additional components and/or may not have all components listed above.

Some of the user requests configurations that may be made available to administrators are shown listed in user requests configurations 2102. Currently shown in FIG. 21 are reset password, deactivate, edit user, and app request. Other user requests configurations may also be made available to the users. As shown, the administrator can activate or deactivate a user request using a sliding gesture. However, other gestures, buttons, or other selection techniques are also possible. Selecting alerts settings button 2101 from the user requests settings page 2100 brings the administrator back to alerts setting page 2000.

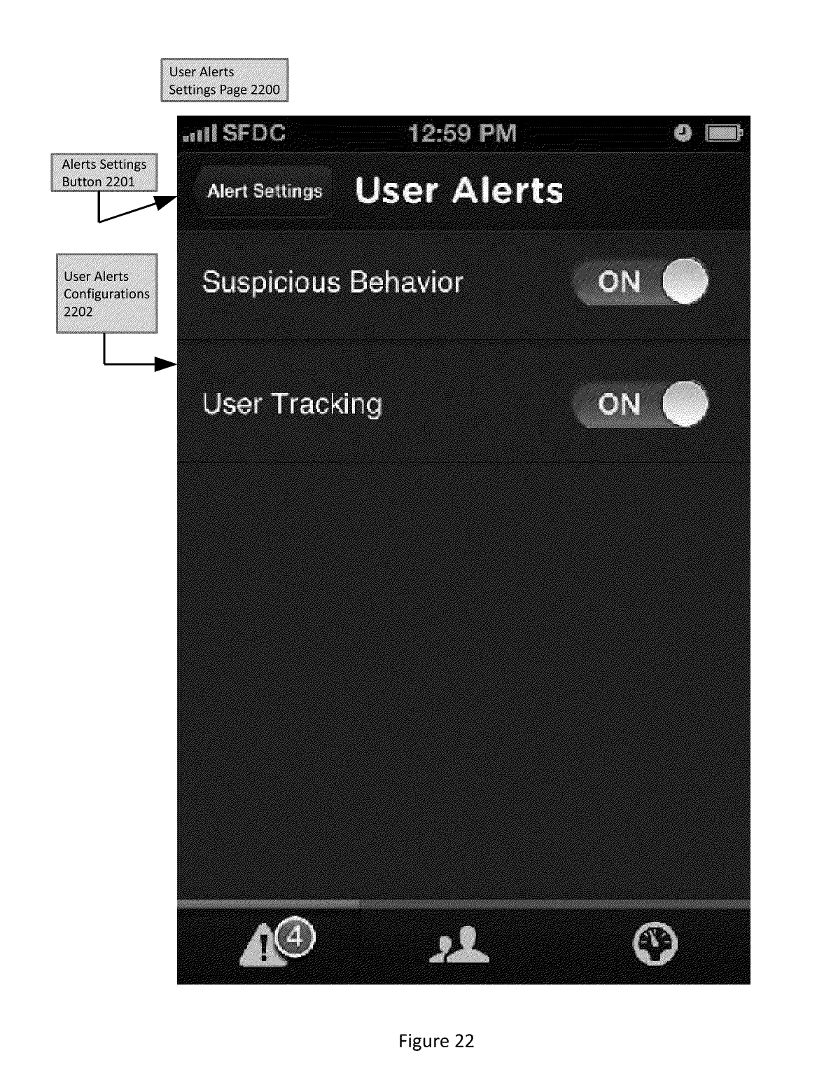

FIG. 22 shows a screenshot of an embodiment of a user alerts setting page 2200. User alerts settings page 2200 includes alerts settings button 2201 and user alerts configurations 2202. In other embodiments user alerts settings page 2200 may have additional components and/or may not have all components listed above.

Some of the user alerts configurations that may be made available to administrators are shown listed in user alerts configurations 2202. Some of the user alerts configurations that may be made available to administrators are suspicious behavior and user tracking alerts, but other alerts may also be available. The administrator can activate or deactivate a user alert using a sliding gesture. However, other gestures, buttons, or other selection techniques are also possible. An administrator may also be able to customize alerts to users in a specific organization, location, to data residing in a certain database or datacenter, etc. Selecting alerts settings button 2201 from the user requests settings page 2200 brings the administrator back to alerts setting page 2000.

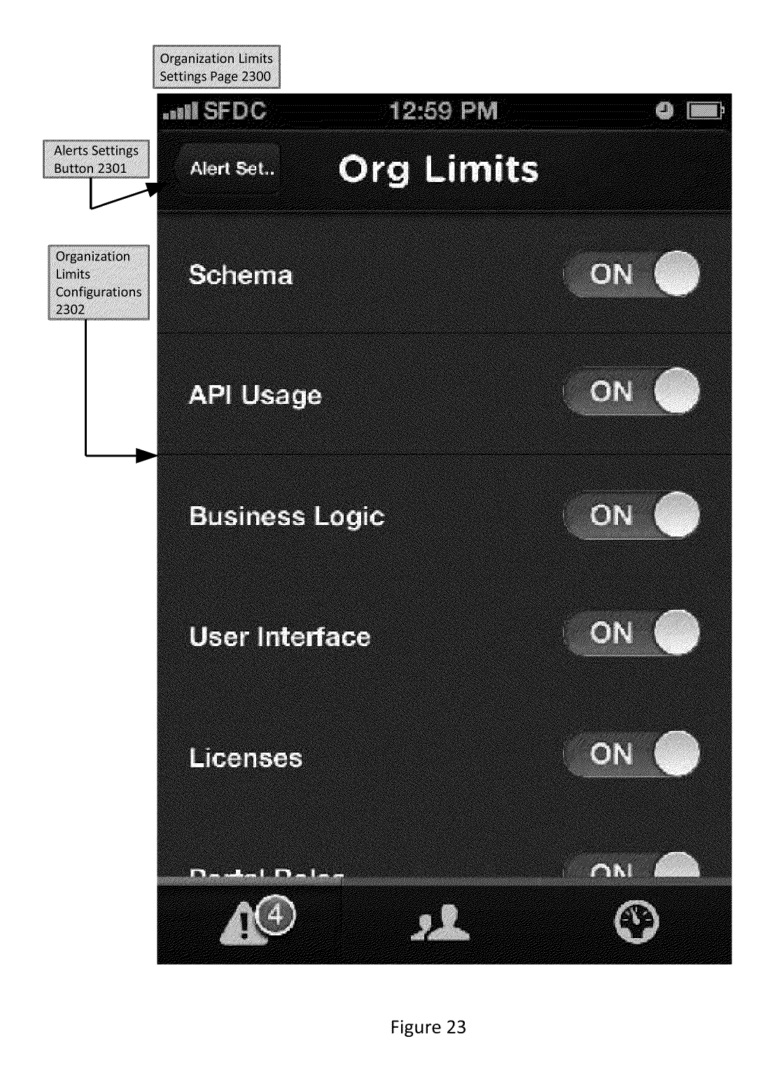

FIG. 23 shows a screenshot of an embodiment of an organization limits settings page 2300. Organization limits settings page 2300 includes alerts settings button 2301 and organization limits configurations 2302. In other embodiments organization limits settings page 2300 may have additional components and/or may not have all components listed above.

Some of the organization limits configurations that may be made available to administrators are shown listed in organization limits configurations 2302. Organization limits may include schema, API usage, business logic, user interface, licenses, etc. Other organization limits may also be available and configurable by the administrator. The administrator can activate or deactivate an organization limit using a sliding gesture. However, other gestures, buttons, or other selection techniques are also possible. Selecting alerts settings button 2301 from the user requests settings page 2300 brings the administrator back to alerts setting page 2000.

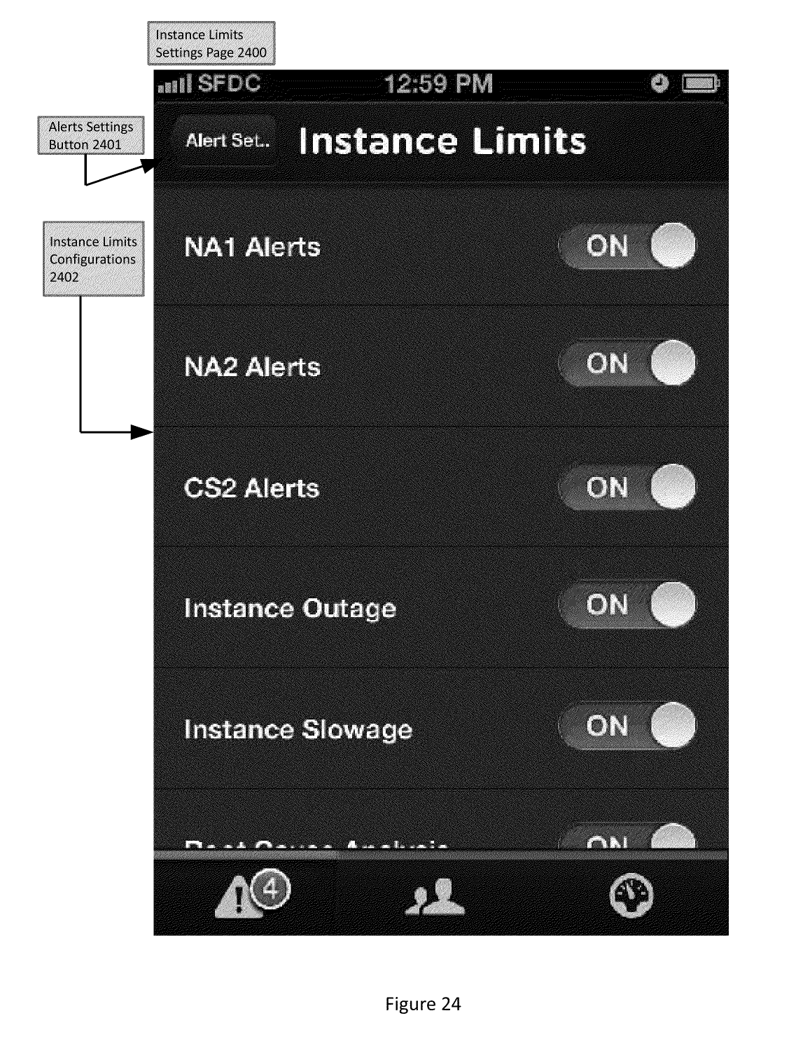

FIG. 24 shows a screenshot of an embodiment of an instance limit settings page 2400. In an embodiment, instance limit settings page 2400 includes alerts settings button 2401 and instance limits configurations 2402. In other embodiments instance limits settings page 2400 may have additional components and/or may not have all components listed above.

Some of the instance limits that may be set by the administrator to help manage one or more instances of the multi-tenant database system are shown in instance limits configurations 2402. Some of the instance limits may include alerts that are specific to a particular instance of the database, such as NA1 Alerts, NA2 Alerts, CS2 Alerts. Some of the instance limit alerts may include instance outage, and instance slowage, for example. Other instance limits may also be available. As shown, the administrator can activate, deactivate and/or select an instance limit using a sliding gesture. However, other gestures, buttons, or other selection techniques are also possible. Selecting alerts settings button 2401 from the user requests settings page 2400 brings the administrator back to alerts setting page 2000.

User management (among other things) will be discussed, below, in conjunction with FIGS. 25-29, and was also discussed above in conjunction with FIGS. 3, 7, and 11.

FIG. 25 shows a screenshot of an embodiment of a user directory page. User directory page 2500 includes user search field 2501, user directory 2502, menu bar 2503, and add user button 2504. In other embodiments user directory page 2500 may have additional components and/or may not have all components listed above.

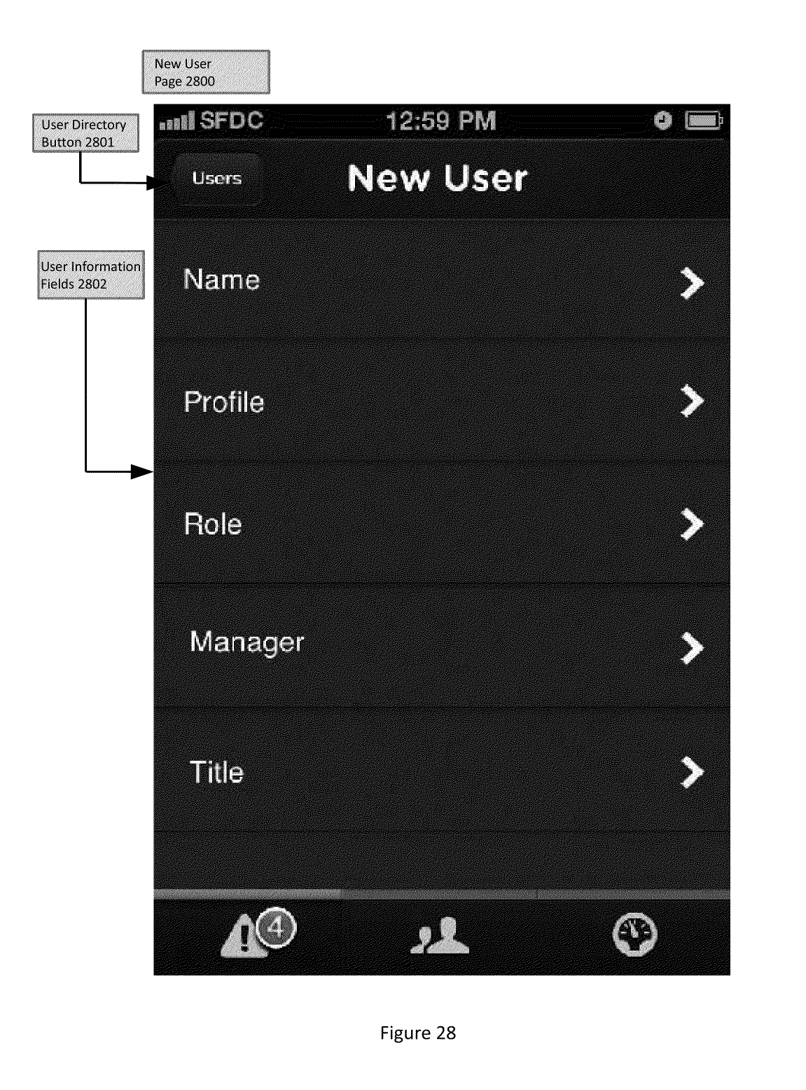

An administrator may be responsible for managing and configuring users who have access to the multi-tenant database system. The administrator may access user directory page 2500 by selecting the user management system tab in menu bar 2503. Menu bar 2503 is the same as menu bar 1404, except as shown, the user management system tab is currently selected with a colored bar above the tab. User directory 2502 is an example of a directory that the administrator can use to navigate to respective user profiles or accounts. The administrator may also search for a particular user by typing in the user's name in user search field 2501. In user directory 2502 user Mike Smith is selected. In one or more implementations, the administrator may be limited to the type of account information available in the application. For example, while the administrator may have complete management privileges over a user account when operating a computer that is directly connected to the network, the mobile application may be limited to addressing security or bandwidth issues. A new user may be added to user directory 2502 by selecting the add user button 2504 (as may be discussed further in conjunction with FIG. 28).

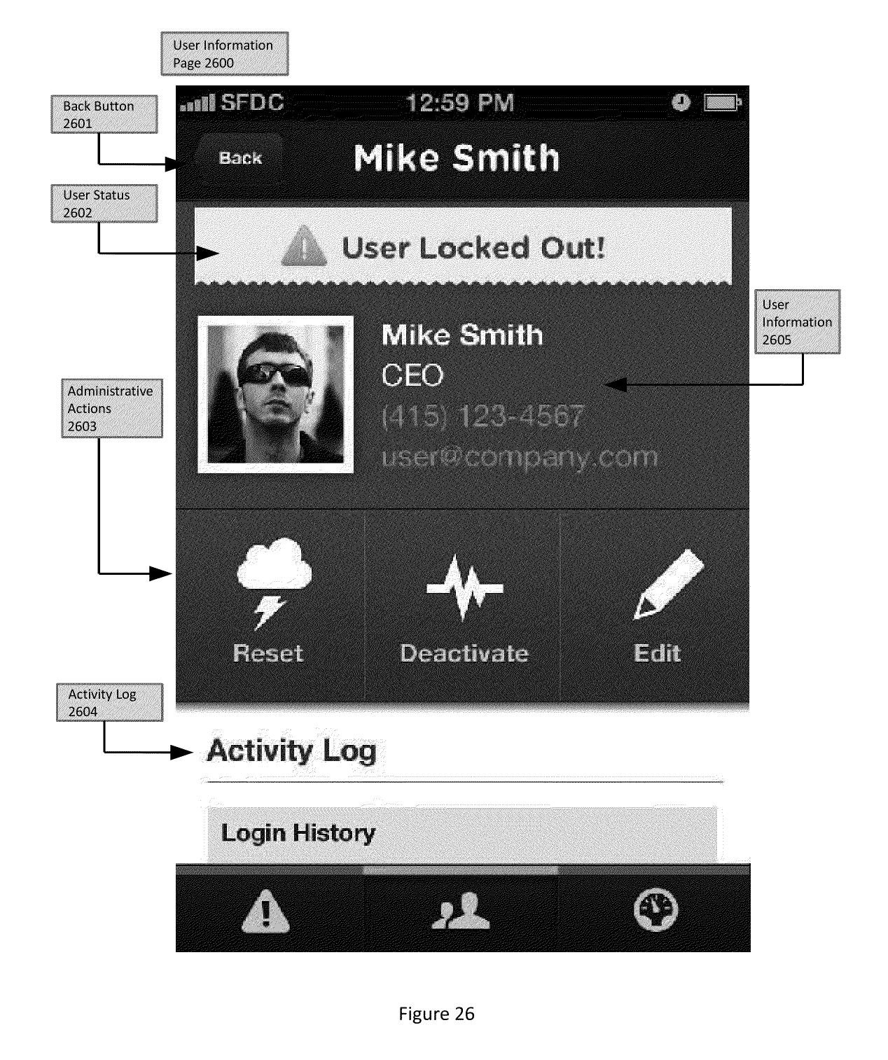

FIG. 26 shows a screenshot of an embodiment of a user information page 2512. User information page 2512 includes back button 2601, user status 2602, administrative actions 2603, activity log 2604, and user information 2605. In other embodiments user information page 2512 may have additional components and/or may not have all components listed above.

Selecting the Mike Smith user account from user directory 2502 in FIG. 25 may lead to a screen with additional details, as shown in user information page 2512. User status 2602 displays the user's current status within the database. In this example, user Mike Smith appears to be locked out. User information page 2512 also lists user information 2605, such as contact information, job title, phone, email, and other information. Additionally or alternatively, user information page 2512 may include various administrative actions 2603. Here, the administrator can reset, deactivate, or edit the user account. Other actions may also be made available. For example, an administrator with privileges over multiple organizations and/or instances may be able to migrate or increase user access to different organizations and/or instances. There may also be options for granular level access. For example, the administrator may be able to configure user access to only certain data depending upon the user's location as indicated by the user's mobile device or computer. If the user is at a work office, the user may access more data than if the user is at a customer site. User information page 2512 also displays the user's activity, such as login history, on the database in activity log 2604. Other activities may also be made available. Selecting back button 2601 from the user information page 2512 brings the administrator back to user directory page 2500.

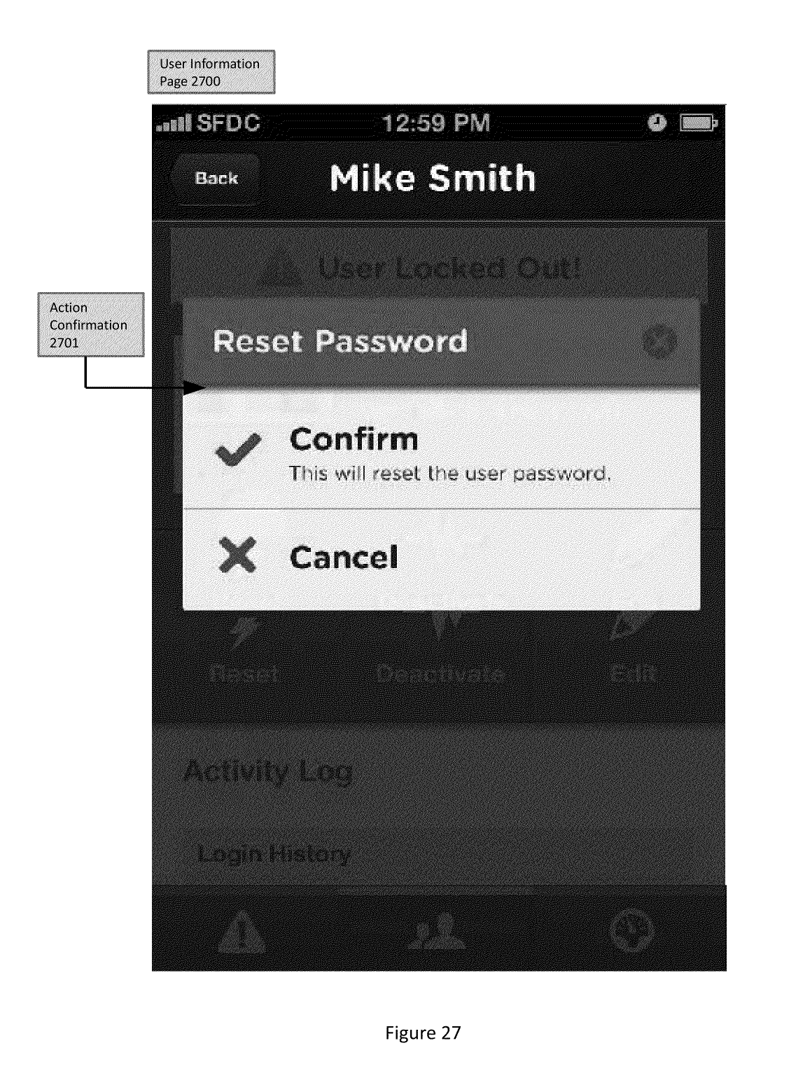

FIG. 27 shows a screenshot of an embodiment of an action confirmation screen for user information page 2514. User information page 2514 is the same as user information page 2512, except that an action confirmation screen is present. User information page 2514 includes action confirmation 2701. In other embodiments user information page 2514 may have additional components and/or may not have all components listed above.

Each action taken by the administrator may require an action confirmation 2701, since such actions can affect user access. Action confirmation 2701 is an example action confirmation screen for a password reset, giving the administrator the option to confirm or cancel the action. Other confirmation screens may be available depending upon the action being taken.

FIG. 28 shows a screenshot of an embodiment of a new user page 2516. New user page 2516 includes user directory button 2801 and user information fields 2802. In other embodiments new user page 2516 may have additional components and/or may not have all components listed above.

One or more implementations may include the ability to add a user to an organization. An administrator may access new user page 2516 by selecting add user button 2504 (as discussed in FIG. 25). The information required for each user may vary according to the administrator's database configuration, but may include the new user's name, profile (e.g., link to Chatter profile page or type of pre-configured access profile), role, manager, title, etc. This information may be stored by selecting the corresponding field in user information fields 2802 and entering the information. The mobile application may only require and/or display some of the information for a new user. More information may be entered when the administrator is at a desktop or laptop console. Selecting user directory button 2801 from the new user page 2516 brings the administrator back to user directory page 2500.

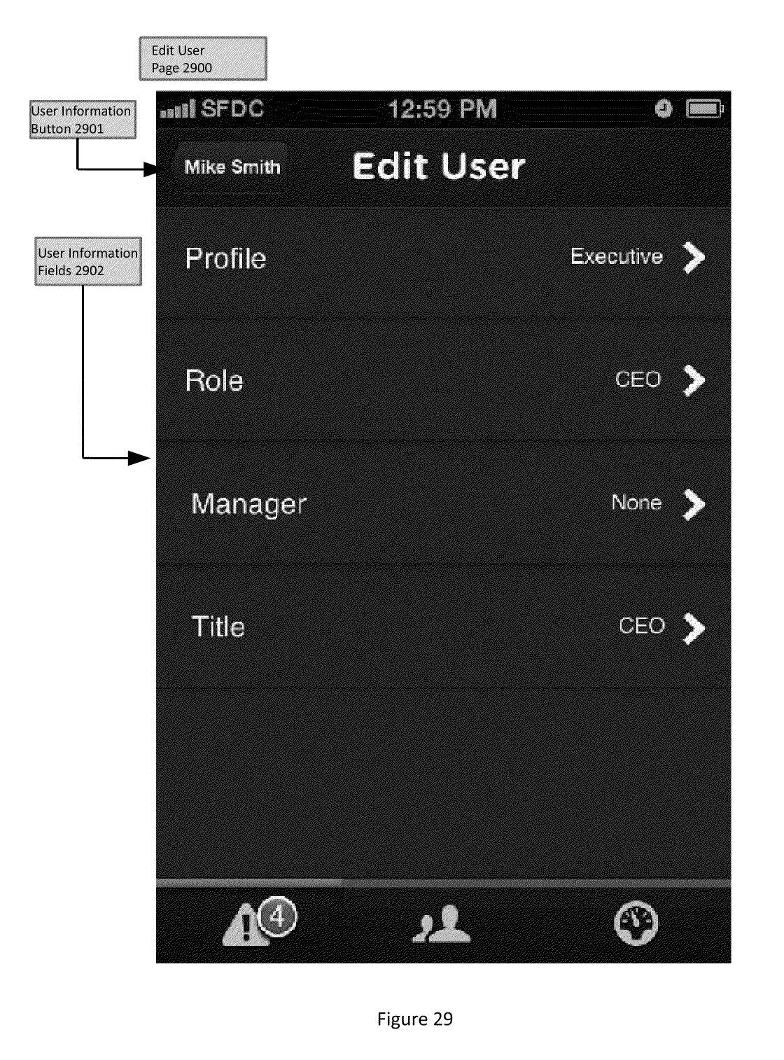

FIG. 29 shows a screenshot of an embodiment of an edit user page 2900. Edit user page 2900 includes user information button 2901 and user information fields 2902. In other embodiments new user page 2516 may have additional components and/or may not have all components listed above.

One or more implementations may include the ability to edit the information for an existing user, as shown on the screen in FIG. 29. Edit user page 2900 may be accessed by selecting the edit action in administrative actions 2603 from user information page 2512 (as discussed in FIG. 26). Any of the information required and/or displayed on new user page 2516 may be edited, or editable information may be limited, depending on the configuration. FIG. 29 shows user information fields 2902 with options to edit a user's access Profile, Role, Manager, and Title. Other editable information may also be available. Selecting user information button 2901 brings the administrator back to user information page 2512 of the user being edited.

Status monitoring (among other things) will also be discussed further, below, in conjunction with FIGS. 30-34, and was also be discussed, above, in conjunction with FIGS. 4, 8, and 12.

FIG. 30 shows a screenshot of an embodiment of a status monitoring page. Status monitoring page 3000 includes datacenter status 3001, organization status 3002, monitoring details 3003, menu bar 3004, and reporting button 3005. In other embodiments new status monitoring page 3000 may have additional components and/or may not have all components listed above. One or more implementations may include the ability to monitor the status of an instance, a datacenter, a server, etc. This may include detailed information on the status, as shown in FIG. 30. The administrator may access status monitoring page 3000 by selecting the status monitoring system tab in menu bar 3004. Menu bar 3004 is the same as menu bar 1404, except as shown, the status monitoring system tab is currently selected with a colored bar above the tab.

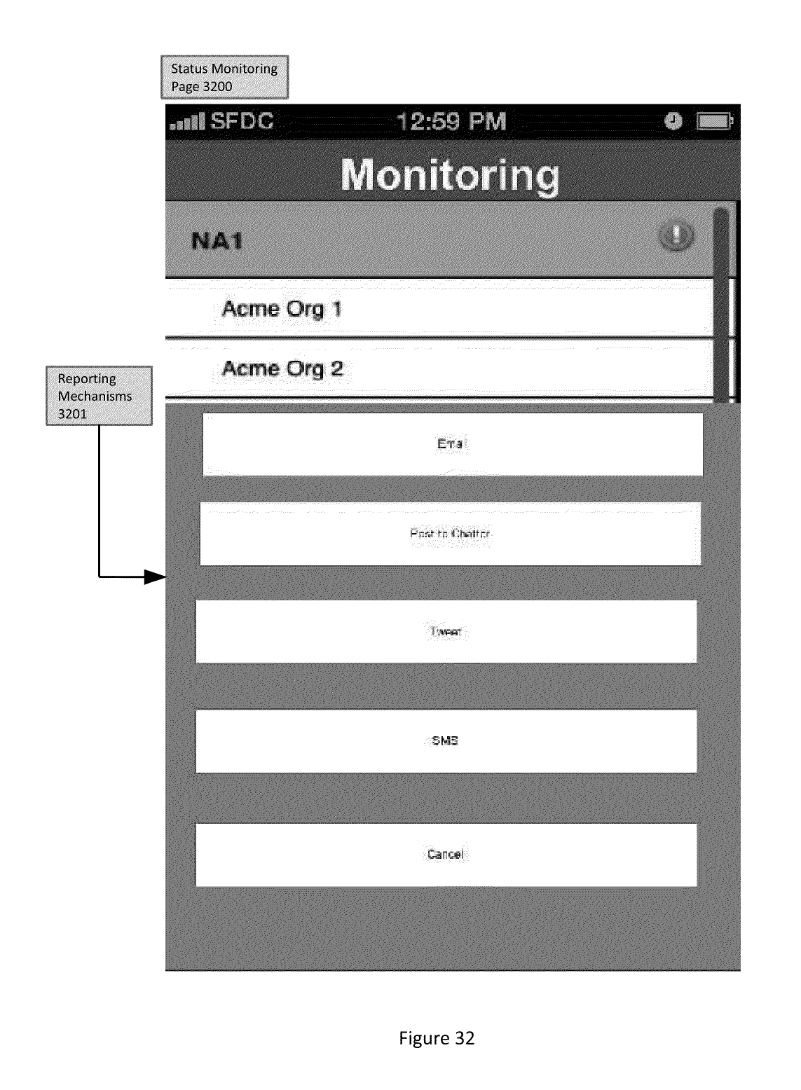

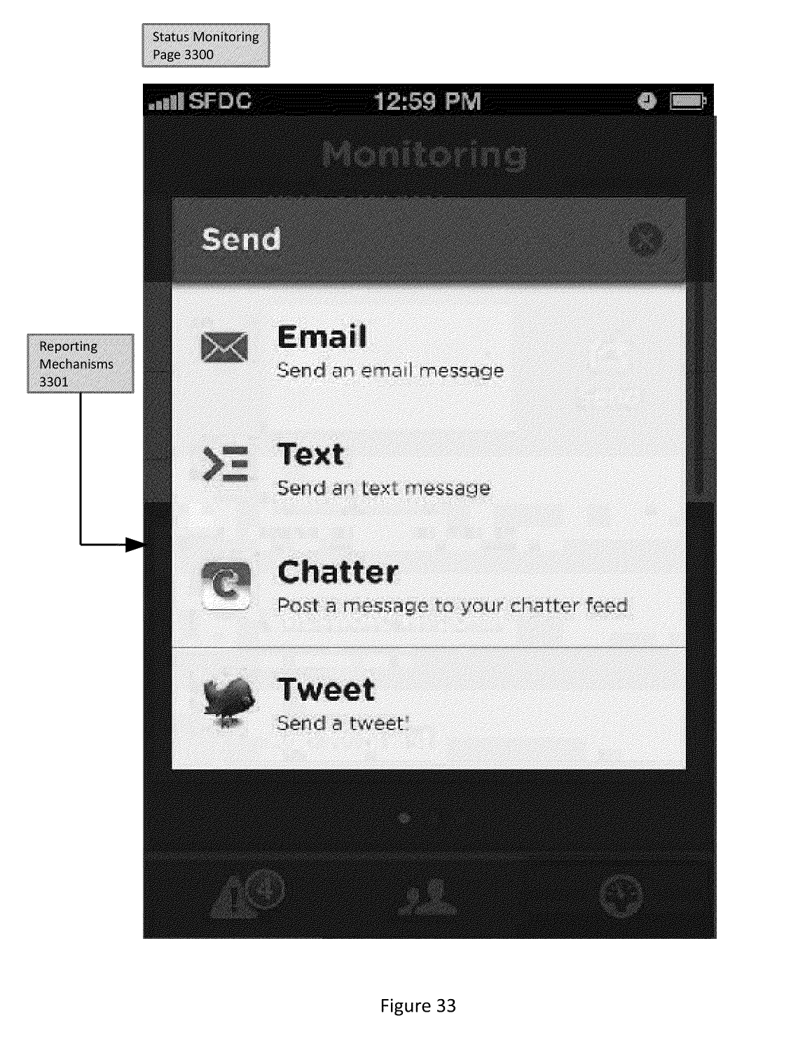

Status monitoring page 3000 shows that the administrator can check the datacenter status 3001 of the NA1 datacenter, as well as the organization status 3002 of the Acme Org 1 and Acme Org 2 instances running on the NA1 datacenter. For each instance, the administrator can view monitoring details 3003, such as login, search, mobile, API, email to lead, email to case, web to lead, and web to case statuses. Currently selected in FIG. 30 is the NA1 datacenter status and shown are monitoring details 3003 of the NA1 datacenter. In FIG. 30, green checkmarked circles may indicate a positive status. Other information may also be available per the administrator's configuration or needs. Status information can be transmitted to others using reporting button 3005 (as may be discussed further in conjunction with FIGS. 32 and 33).

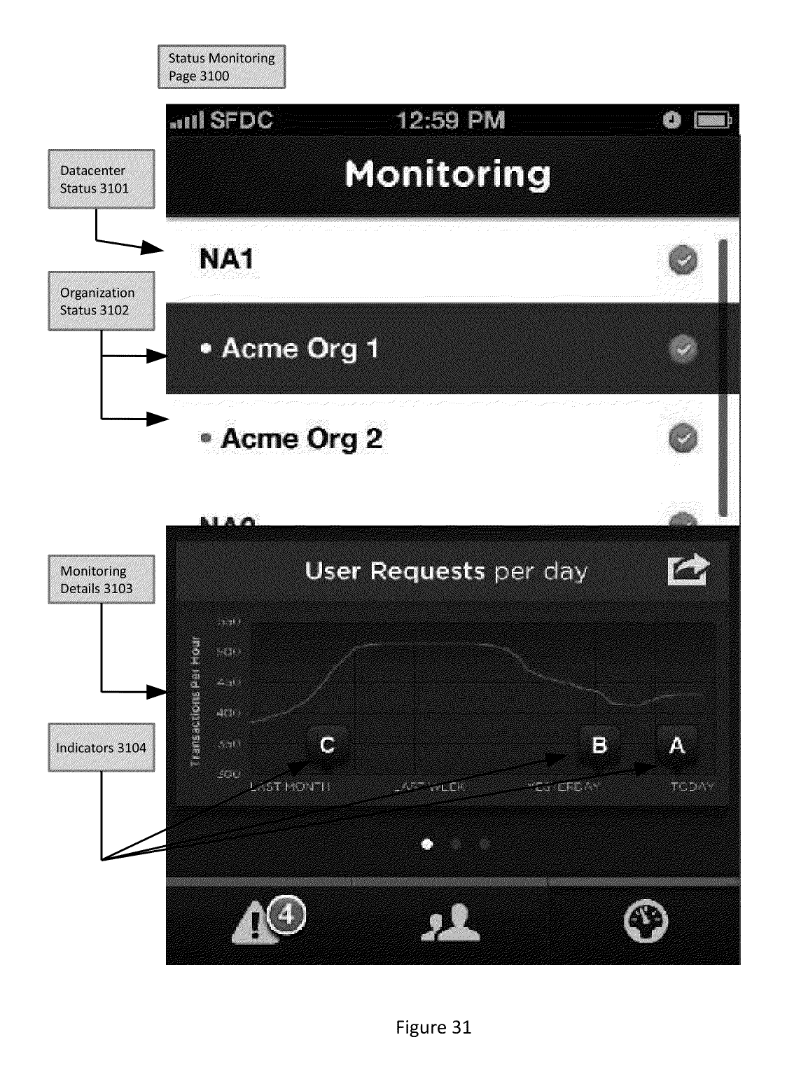

FIG. 31 shows a screenshot of an embodiment of another view of a status monitoring page 3100. Status monitoring page 3100 includes datacenter status 3101, organization status 3102, monitoring details 3103, and indicators 3104. In other embodiments new status monitoring page 3100 may have additional components and/or may not have all components listed above.

Status monitoring page 3100 is the same as status monitoring page 3000, except the Acme Org 1 instance has been selected and monitoring details 3103 of Acme Org 1 instance are shown. The datacenter status 3101 of the NA1 datacenter is the same as datacenter status 3001, except that it is not selected in FIG. 31.

FIG. 31 shows additional monitoring details 3103 for Acme Org 1 which is operating on the NA1 datacenter. These details may be displayed upon clicking the respective instance in organization status 3002. Shown in monitoring details 3103 is a graphic on user requests per day, but other information may also be available for display and/or transmission to others. There may also be an option to “drill-down” or explore certain events or additional details. This may be directly accessible in the display by clicking certain indicators 3104 (e.g., the A, B, or C in FIG. 19) or by scrolling or other user gestures.

FIG. 32 shows a screenshot of an embodiment of reporting mechanisms within a status monitoring page 3200. Status monitoring page 3200 includes reporting mechanisms 3201. In other embodiments new status monitoring page 3100 may have additional components and/or may not have all components listed above. Status monitoring page 3200 is the same as status monitoring page 3000, except reporting mechanisms 3201 have been accessed. Reporting mechanisms 3201 can be used to transmit information to others. Status monitoring page 3200 may be an alternate display to that shown in FIG. 18.

FIG. 33 shows another screenshot of an embodiment of reporting mechanisms within a status monitoring page 3300. Status monitoring page 3300 includes reporting mechanisms 3301. In other embodiments new status monitoring page 3300 may have additional components and/or may not have all components listed above.

Status monitoring page 3300 is the same as status monitoring page 3200, except different reporting mechanisms 3301 are shown. Reporting mechanisms 3301 can be used to transmit information to others. Reporting mechanisms 3301 is similar to the embodiment shown in FIG. 18, but specific to the monitoring page.

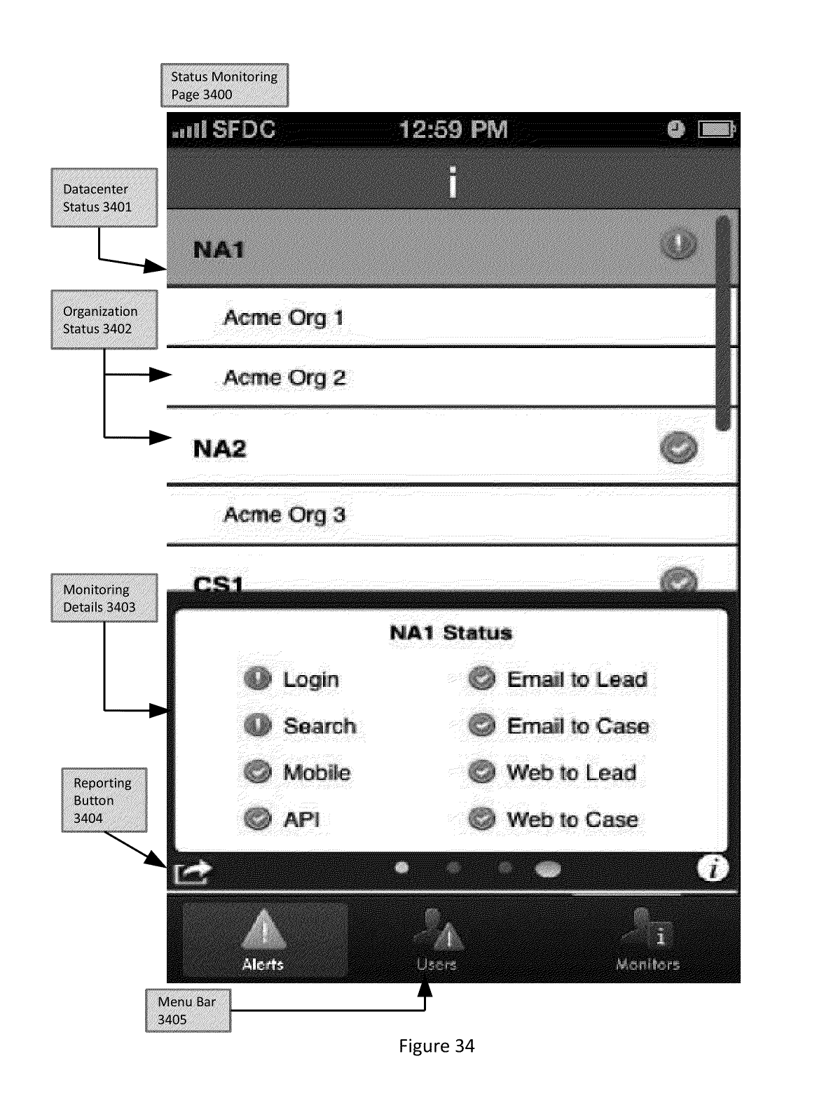

FIG. 34 shows a screenshot of an embodiment of another view of a status monitoring page 3400. Status monitoring page 3400 includes datacenter status 3401, organization status 3402, monitoring details 3403, reporting mechanism 3404, and menu bar 3405. In other embodiments new status monitoring page 3400 may have additional components and/or may not have all components listed above.

Status monitoring page 3400 is the same as status monitoring page 3000, except several indicators identify existing issues within monitoring details 3403 of the NA1 datacenter. Various visual indicators can be used to readily identify whether there are any issues. In FIG. 33, green checkmarked circles may indicate a positive status, whereas a red exclamation point in a circle may indicate an issue that requires further attention. Reporting button 3404 is the same as reporting button 3005, and menu bar 3405 is the same as menu bar 3004.

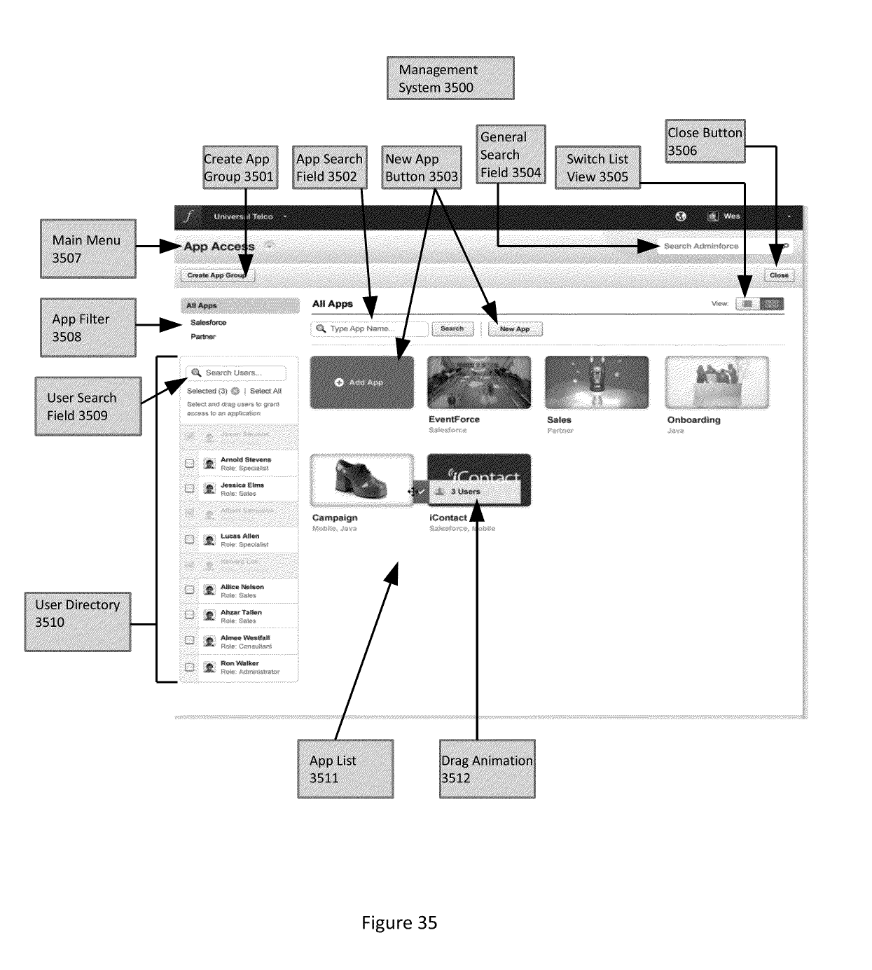

FIG. 35 shows a screenshot of an embodiment of another implementation of the mobile multi-tenant database management system 3500. Management system 3500 includes create app group 3501, app search field 3502, new app button 3503, general search field 3504, switch list view 3505, close button 3506, main menu 3507, app filter 3508, user search field 3509, user directory 3510, app list 3511, and drag animation 3512. In other embodiments management system 3500 may have additional components and/or may not have all components listed above.

As the above figures and this disclosure indicate, a mobile application for administrating one or more tenants on a multi-tenant database system has many potential benefits. Other configurations and implementations are also possible, and the examples and screens described herein are not intended to limit this disclosure in any fashion. For example, while the previous examples showcase administration tasks on an iPhone or smaller mobile device screen, a larger screen, such as that provided by an iPad or similar mobile device, may allow for additional actions.

FIG. 35 is a screenshot of a mobile administration management system 3500 running on a larger mobile device, such as an iPad. As shown app access has been chosen in main menu 3507 to bring up the apps main page showing apps list 3511. The administrator may switch the list format by using switch list view 3505 to toggle between a tile view and list view. Other list formats may be available in other implementations. An administrator may use app search field 3502 to search for a particular app on the system. An administrator may also filter the available apps by category with app filter 3508. In FIG. 35, all apps is currently selected with the Salesforce and partner categories shown. Other categories may be available in other implementations and can be created by the administrator using create app group 3501. Here an administrator or user with sufficient privileges may have the ability to install or add applications to a platform running on the multi-tenant database system using the new app button 3503 located both at the top of the app list and/or within the app list.

While applications are shown, alternate or additional implementations could include the ability to add one or more users to an organization, or an instance for an organization. Also shown in management system 3500 is user directory 3510, which is similar to user directory 2502 in user directory page 2500 shown in FIG. 25, except that user directory 3510 can be shown concurrently with the app access page or other pages selected in main menu 3507. An administrator may search for a particular user by scrolling through user directory 3510 or by entering the user's name in user search field 3509. Users or an organization can be dragged to an available application or instance, shown as drag animation 3512, thereby initiating a set of process for enabling access and executing code without the need to configure user profiles or edit permissions. Selecting close button 3506 may exit the current Apps Access page and return to a home page or other previously accessed page.

Regarding FIGS. 13-36, in an embodiment, the application installed on the user mobile device generates the format of each page (e.g., the interface rendered to the user device), while the information is retrieved from the multitenant database being managed. In an embodiment, at least each time a page is displayed, the user device requests the information or an update to the information from the multitenant database, and the multitenant database retrieves the information or an update to the information, formats the information for the user mobile device, and then sends the information either directly to the user mobile device or to the user mobile device, via a push service provider, such as Apple® or Google®.

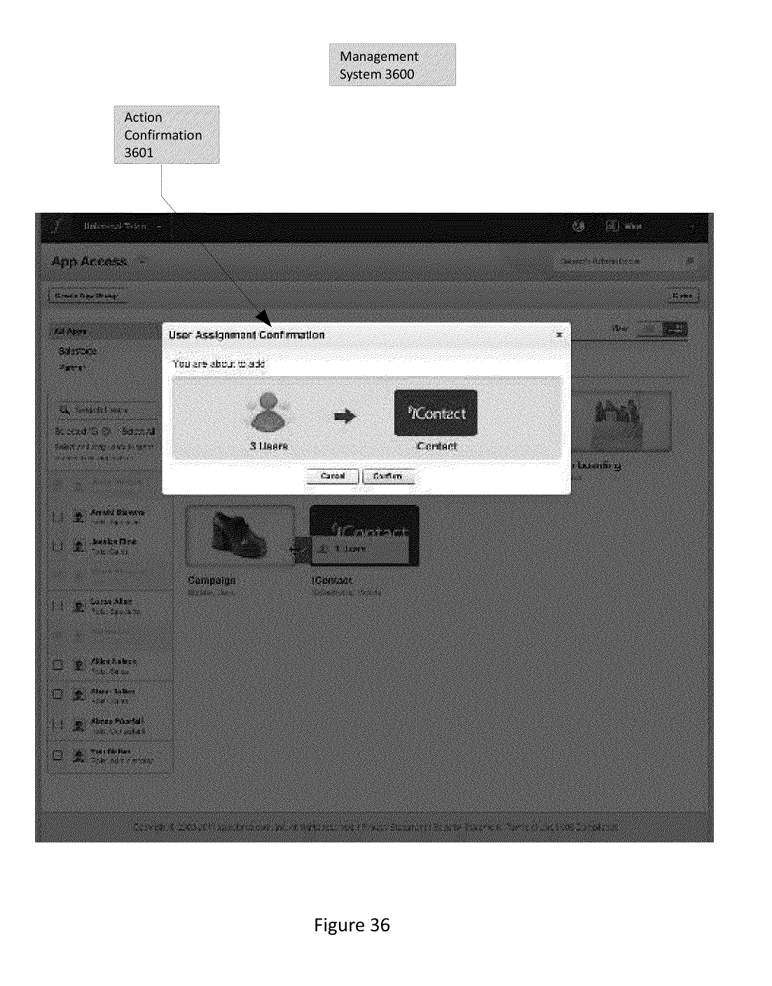

FIG. 36 shows a screenshot of an embodiment of a confirmation screen for approval to install the “iContact” application on management system 3512. Management system 3512 is the same as management system 3500, except a confirmation screen has been activated. Management system 3512 includes action confirmation 3601. In other embodiments management system 3512 may have additional components and/or may not have all components listed above.

In FIG. 36, three users have been dragged to the application (as shown by drag animation 3512 in FIG. 35), though other gestures could be used as well. Dragging users to an application the administrator may require an action confirmation 3601, since such actions can affect user access. Action confirmation 3601 is an example action confirmation screen for a user assignment, giving the administrator the option to confirm or cancel the action. Other confirmation screens may be available depending upon the action being taken.

Once confirmed, each user account may reflect that the user account now has access to the application. Using the mobile administration application detailed above or a similar implementation, the administrator can fine tune or edit individual user accounts for more granular configurations. In this fashion, the administrator can use a mobile application to add or make changes to individual or multiple user accounts, individual or multiple instances, etc., without having to rely upon access through a desktop, laptop, or other less mobile interface.

### System Overview

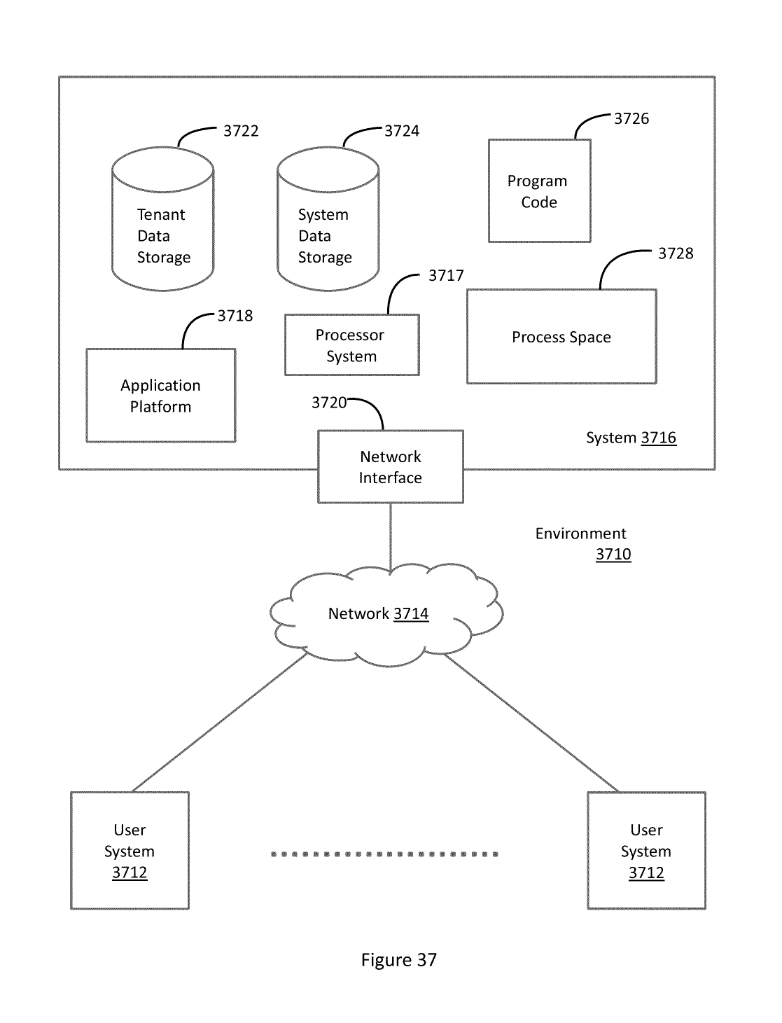

FIG. 37 illustrates a block diagram of an environment 3710 wherein an on-demand database service might be used. Environment 3710 may include user systems 3712, network 3714, system 3716, processor system 3717, application platform 3718, network interface 3720, tenant data storage 3722, system data storage 3724, program code 3726, and process space 3728. In other embodiments, environment 3710 may not have all of the components listed and/or may have other elements instead of, or in addition to, those listed above.

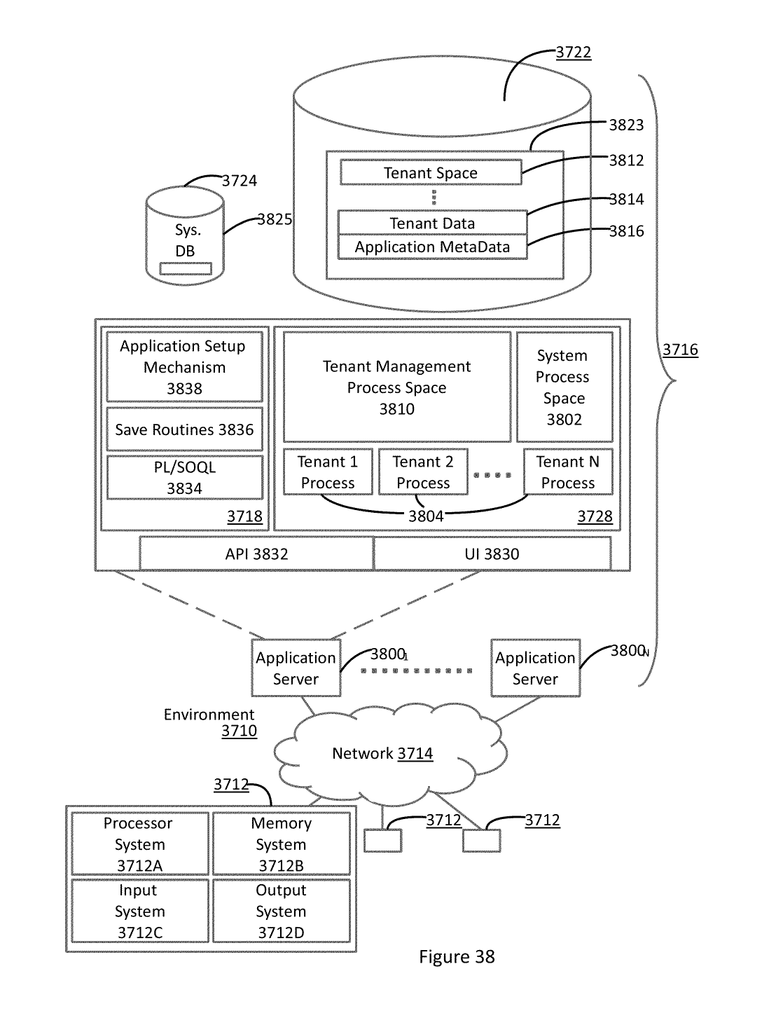

Environment 3710 is an environment in which an on-demand database service exists. User system 3712 may be any machine or system that is used by a user to access a database user system. For example, any of user systems 3712 can be a handheld computing device, a mobile phone, a laptop computer, a work station, and/or a network of computing devices. As illustrated in FIG. 37 (and in more detail in FIG. 38) user systems 3712 might interact via a network 3714 with an on-demand database service, which is system 3716. One or more of user system 3712 may the mobile user device discussed above or the alert monitoring system 100 of FIG. 1.

An on-demand database service, such as system 3716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 3716” and “system 3716” will be used interchangeably herein. A database image may include one or more database objects. A relational database management system (RDMS) or the equivalent may execute storage and retrieval of information against the database object(s). Application platform 3718 may be a framework that allows the applications of system 3716 to run, such as the hardware and/or software, e.g., the operating system. In an embodiment, on-demand database service 3716 may include an application platform 3718 that enables creation, managing and executing one or more applications developed by the provider of the on-demand database service, users accessing the on-demand database service via user systems 3712, or third party application developers accessing the on-demand database service via user systems 3712.

The users of user systems 3712 may differ in their respective capacities, and the capacity of a particular user system 3712 might be entirely determined by permissions (permission levels) for the current user. For example, where a salesperson is using a particular user system 3712 to interact with system 3716, that user system has the capacities allotted to that salesperson. However, while an administrator is using that user system to interact with system 3716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 3714 is any network or combination of networks of devices that communicate with one another. For example, network 3714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 3712 might communicate with system 3716 using TCP/IP and, at a higher network level, use other common Internet protocols to communicate, such as HTTP, FTP, AFS, WAP, etc. In an example where HTTP is used, user system 3712 might include an HTTP client commonly referred to as a “browser” for sending and receiving HTTP messages to and from an HTTP server at system 3716. Such an HTTP server might be implemented as the sole network interface between system 3716 and network 3714, but other techniques might be used as well or instead. In some implementations, the interface between system 3716 and network 3714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 3716, shown in FIG. 37, implements a web-based customer relationship management (CRM) system. For example, in one embodiment, system 3716 includes application servers configured to implement and execute CRM software applications as well as provide related data, code, forms, webpages and other information to and from user systems 3712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 3716 implements applications other than, or in addition to, a CRM application. For example, system 3716 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 3716.

One arrangement for elements of system 3716 is shown in FIG. 37, including a network interface 3720, application platform 3718, tenant data storage 3722 for tenant data 3823, system data storage 3724 for system data 3825 accessible to system 3716 and possibly multiple tenants, program code 3726 for implementing various functions of system 3716, and a process space 3728 for executing MTS system processes and tenant-specific processes, such as running applications as part of an application hosting service. Additional processes that may execute on system 3716 include database indexing processes.

Several elements in the system shown in FIG. 37 include conventional, well-known elements that are explained only briefly here. For example, each user system 3712 could include a desktop personal computer, workstation, laptop, PDA, cell phone, or any wireless access protocol (WAP) enabled device or any other computing device capable of interfacing directly or indirectly to the Internet or other network connection. User system 3712 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 3712 to access, process and view information, pages and applications available to it from system 3716 over network 3714. Each user system 3712 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 3716 or other systems or servers. For example, the user interface device can be used to access data and applications hosted by system 3716, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 3712 and all of its components are operator configurable using applications, such as a browser, including computer code run using a central processing unit such as an Intel Pentium® processor or the like. Similarly, system 3716 (and additional instances of an MTS, where more than one is present) and all of their components might be operator configurable using application(s) including computer code to run using a central processing unit such as processor system 3717, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 3716 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 3716 is configured to provide webpages, forms, applications, data and media content to user (client) systems 3712 to support the access by user systems 3712 as tenants of system 3716. As such, system 3716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 38 also illustrates environment 3710. However, in FIG. 38 elements of system 3716 and various interconnections in an embodiment are further illustrated. FIG. 38 shows that user system 3712 may include processor system 3712A, memory system 3712B, input system 3712C, and output system 3712D. FIG. 37 shows network 3714 and system 3716. FIG. 38 also shows that system 3716 may include tenant data storage 3722, tenant data 3823, system data storage 3724, system data 3825, User Interface (UI) 3830, Application Program Interface (API) 3832, PL/SOQL 3834, save routines 3836, application setup mechanism 3838, applications servers 38001-3800N, system process space 3702, tenant process spaces 3704, tenant management process space 3710, tenant storage area 3712, user storage 3714, and application metadata 3716. In other embodiments, environment 3710 may not have the same elements as those listed above and/or may have other elements instead of, or in addition to, those listed above.

User system 3712, network 3714, system 3716, tenant data storage 3722, and system data storage 3724 were discussed above in FIG. 37. Regarding user system 3712, processor system 3712A may be any combination of one or more processors. Memory system 3712B may be any combination of one or more memory devices, short term, and/or long term memory. Input system 3712C may be any combination of input devices, such as one or more keyboards, mice, trackballs, scanners, cameras, and/or interfaces to networks. Output system 3712D may be any combination of output devices, such as one or more monitors, printers, and/or interfaces to networks. As shown by FIG. 37, system 3716 may include a network interface 3720 (of FIG. 37) implemented as a set of HTTP application servers 3800, an application platform 3718, tenant data storage 3722, and system data storage 3724. Also shown is system process space 3702, including individual tenant process spaces 3704 and a tenant management process space 3710. Each application server 3800 may be configured to tenant data storage 3722 and the tenant data 3823 therein, and system data storage 3724 and the system data 3825 therein to serve requests of user systems 3712. The tenant data 3823 might be divided into individual tenant storage areas 3712, which can be either a physical arrangement and/or a logical arrangement of data. Within each tenant storage area 3712, user storage 3714 and application metadata 3716 might be similarly allocated for each user. For example, a copy of a user's most recently used (MRU) items might be stored to user storage 3714. Similarly, a copy of MRU items for an entire organization that is a tenant might be stored to tenant storage area 3712. A UI 3830 provides a user interface and an API 3832 provides an application programmer interface to system 3716 resident processes to users and/or developers at user systems 3712. The tenant data and the system data may be stored in various databases, such as one or more Oracle™ databases.

Application platform 3718 includes an application setup mechanism 3838 that supports application developers' creation and management of applications, which may be saved as metadata into tenant data storage 3722 by save routines 3836 for execution by subscribers as one or more tenant process spaces 3704 managed by tenant management process 3710 for example. Invocations to such applications may be coded using PL/SOQL 3834 that provides a programming language style interface extension to API 3832. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 3716 for the subscriber making the invocation and executing the metadata as an application in a virtual machine.

Each application server 3800 may be communicably coupled to database systems, e.g., having access to system data 3825 and tenant data 3823, via a different network connection. For example, one application server 38001 might be coupled via the network 3714 (e.g., the Internet), another application server 3800N-1 might be coupled via a direct network link, and another application server 3800N might be coupled by yet a different network connection. Transfer Control Protocol and Internet Protocol (TCP/IP) are typical protocols for communicating between application servers 3800 and the database system. However, it will be apparent to one skilled in the art that other transport protocols may be used to optimize the system depending on the network interconnect used.

In certain embodiments, each application server 3800 is configured to handle requests for any user associated with any organization that is a tenant. Because it is desirable to be able to add and remove application servers from the server pool at any time for any reason, there is preferably no server affinity for a user and/or organization to a specific application server 3800. In one embodiment, therefore, an interface system implementing a load balancing function (e.g., an F5 Big-IP load balancer) is communicably coupled between the application servers 3800 and the user systems 3712 to distribute requests to the application servers 3800. In one embodiment, the load balancer uses a least connections algorithm to route user requests to the application servers 3800. Other examples of load balancing algorithms, such as round robin and observed response time, also can be used. For example, in certain embodiments, three consecutive requests from the same user could hit three different application servers 3800, and three requests from different users could hit the same application server 3800. In this manner, system 3716 is multi-tenant, wherein system 3716 handles storage of, and access to, different objects, data and applications across disparate users and organizations.

As an example of storage, one tenant might be a company that employs a sales force where each salesperson uses system 3716 to manage their sales process. Thus, a user might maintain contact data, leads data, customer follow-up data, performance data, goals and progress data, etc., all applicable to that user's personal sales process (e.g., in tenant data storage 3722). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 3716 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 3716 might also maintain system level data usable by multiple tenants or other data. Such system level data might include industry reports, news, postings, and the like that are sharable among tenants.

In certain embodiments, user systems 3712 (which may be client systems) communicate with application servers 3800 to request and update system-level and tenant-level data from system 3716 that may require sending one or more queries to tenant data storage 3722 and/or system data storage 3724. System 3716 (e.g., an application server 3800 in system 3716) automatically generates one or more SQL statements (e.g., one or more SQL queries) that are designed to access the desired information. System data storage 3724 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### Method for Using the Environment (FIGS. 37 and 38)

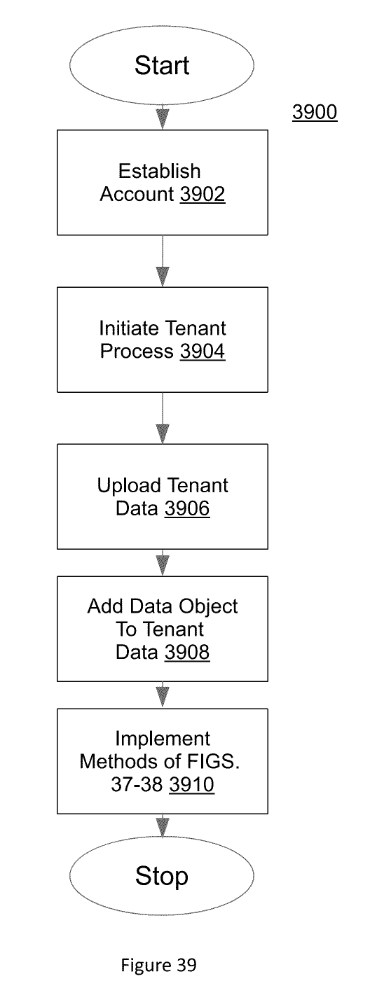

FIG. 39 shows a flowchart of an example of a method 3900 of using environment 3710. In step 3910, user system 3712 (FIGS. 37 and 37) establishes an account. In step 3912, one or more tenant process space 3804 (FIG. 38) are initiated on behalf of user system 3712, which may also involve setting aside space in tenant space 3812 (FIG. 38) and tenant data 3814 (FIG. 38) for user system 3712. Step 3912 may also involve modifying application metadata to accommodate user system 3712. In step 3914, user system 3712 uploads data. In step 3916, one or more data objects are added to tenant data 3814 where the data uploaded is stored. In step 3918, the methods associated with FIGS. 1-38 may be implemented. In another embodiment, although depicted as distinct steps in FIG. 39, steps 3902-3918 may not be distinct steps. In other embodiments, method 3900 may not have all of the above steps and/or may have other steps in addition to, or instead of, those listed above. The steps of method 3900 may be performed in another order. Subsets of the steps listed above as part of method 3900 may be used to form their own method.

### Method for Creating the Environment (FIGS. 37 and 38)

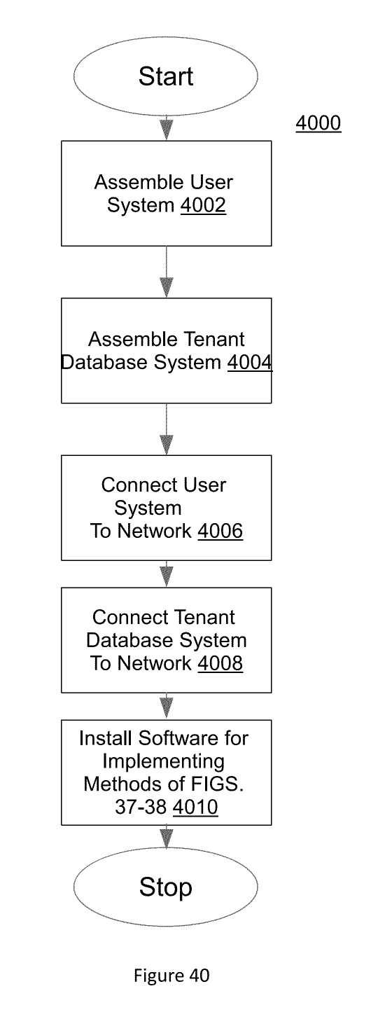

FIG. 40 is a method of making environment 3710, in step 4002, user system 3712 (FIGS. 37 and 38) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 4004, system 3716 (FIGS. 37 and 38) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another. Additionally assembling system 3716 may include installing application platform 3718, network interface 3720, tenant data storage 3722, system data storage 3724, system data 3825, program code 3726, process space 3728, UI 3830, API 3832, PL/SOQL 3834, save routine 3836, application setup mechanism 3838, applications servers 100₁-100_{N}, system process space 102, tenant process spaces 3804, tenant management process space 110, tenant space 3812, tenant data 3814, and application metadata 116 (FIG. 38).

In step 4006, user system 3712 is communicatively coupled to network 3804. In step 4008, system 3716 is communicatively coupled to network 3804 allowing user system 3712 and system 3716 to communicate with one another (FIG. 38). In step 4010, one or more instructions may be installed in system 3716 (e.g., the instructions may be installed on one or more machine readable media, such as computer readable media, therein) and/or system 3716 is otherwise configured for performing the steps of methods associated with FIGS. 1-38. In an embodiment, each of the steps of method 4000 is a distinct step. In another embodiment, although depicted as distinct steps in FIG. 40, steps 4002-4010 may not be distinct steps. In other embodiments, method 4000 may not have all of the above steps and/or may have other steps in addition to, or instead of, those listed above. The steps of method 4000 may be performed in another order. Subsets of the steps listed above as part of method 4000 may be used to form their own method.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of managing a multi-tenant database with a mobile device comprising:
sending, by a multi-tenant database system including at least a processor system and a memory system, to a user mobile device that stores a client application specific for communicating with the multi-tenant database, information related to managing a multitenant database, the information being sent according to a protocol specific to the application stored on the user mobile device;
receiving, by the multi-tenant database system, a message including an instruction to implement an administrative action on the multi-tenant database system
implementing, by the multi-tenant database system, the administrative action on the multi-tenant database system.

2. The method of claim 1 further comprising:
receiving, by the multi-tenant database system from the user mobile device, a message including a request to view a status of a datacenter running on the multi-tenant database system;
sending, by the multi-tenant database system to the user mobile device, the status of the datacenter; and
receiving, by the multi-tenant database system from the user mobile device, an instruction to implement one or more administrative actions affecting the status of the datacenter;

3. The method of claim 1 further comprising:
receiving, by the multi-tenant database system from the user mobile device, a request to view a status of an instance on a datacenter running on the multi-tenant database system;
sending, by the multi-tenant database system to the user mobile device, the status of the instance on the datacenter; and
receiving, by the multi-tenant database system from the user mobile device, an instruction to implement one or more administrative actions affecting the status of the instance.

4. The method of claim 1 further comprising:
receiving, by the multi-tenant database system from the user mobile device, a request to access a user account on the multi-tenant database system;
sending, by the multi-tenant database system to the user mobile device, access to the user account; and
receiving, by the multi-tenant database system to the user mobile device, an instruction to implement one or more administrative actions affecting the user account.

5. The method of claim 1 further comprising:
sending, by the multi-tenant database system to the user mobile device, one or more messages including at least a notification relating to the status of the multi-tenant database system; and
sending, by the multi-tenant database system to the user mobile device, one or more options to take one or more administrative actions in response to the notification.

6. The method of claim 1, wherein the administrative actions include at least sending a report of a status of the multi-tenant database system, via a network.

7. The method of claim 1, wherein the administrative actions include at least implementing administrative actions for datacenters and instances including at least increasing usage limits.

8. The method of claim 1, wherein the administrative actions include at least delegating the alert to another user or administrator of the multi-tenant database system.

9. The method of claim 1, wherein the administrative actions include at least resetting the user account.

10. The method of claim 1, wherein the administrative actions include at least deactivating the user account.

11. The method of claim 1, wherein the administrative actions include at least edit user account information.

12. The method of claim 1, wherein the administrative actions include at least adding a new user to the multi-tenant database system.

13. The method of claim 1, wherein the administrative actions include at least granting user access to the multi-tenant database system.

14. The method of claim 1, wherein the administrative actions include at least manipulating user access to the multi-tenant database system.

15. A method comprising:
receiving, by a user mobile device via a client application stored and run on the user mobile device, from a multi-tenant database system, information related to managing the multitenant database system from the user mobile device, the user mobile device including at least a processor system and a memory system;
sending, by the user mobile device, via the client application, to the multi-tenant database system, a message including an instruction to implement an administrative action on the multi-tenant database system.

16. The method of claim 15 further comprising:
sending, by the user mobile device, via the client application, to the multi-tenant database system, a message including a request to view a status of a datacenter running on the multi-tenant database system;
receiving, by the user mobile device, via the client application, from the multi-tenant database system, the status of the datacenter; and
sending, by the user mobile device, via the client application, to the multi-tenant database system, an instruction to implement one or more administrative actions affecting the status of the datacenter;
sending, by the user mobile device, via the client application, to the multi-tenant database system, a request to view a status of an instance on a datacenter running on the multi-tenant database system;
receiving, by the user mobile device, via the client application, from the multi-tenant database system, the status of an instance on a datacenter running on the multi-tenant database system; and
sending, by the user mobile device, via the client application, to the multi-tenant database system, an instruction to implement one or more administrative actions affecting the status of the instance.
sending, by the user mobile device, via the client application, to the multi-tenant database system, a request to access a user account on the multi-tenant database system;
receiving, by the user mobile device, via the client application, from the multi-tenant database system, access to the user account on the multi-tenant database system; and
sending, by the user mobile device, via the client application, to the multi-tenant database system, an instruction to implement one or more administrative actions affecting the user account.
receiving, by the user mobile device, via the client application, from the multi-tenant database system, one or more messages including at least a notification relating to the status of the multi-tenant database system; and
receiving, by the user mobile device, via the client application, from the multi-tenant database system, one or more options to take one or more administrative actions in response to the notification.

17. The method of claim 15, wherein the administrative actions include at least
sending a report of the status, via a network;
implementing administrative actions for datacenters and instances including at least increasing usage limits;
delegating the alert to another user or administrator of the multi-tenant database system;
resetting the user account;
deactivating the user account;
edit user account information;
adding a new user to the multi-tenant database system;
granting user access to the multi-tenant database system; and
manipulating user access to the multi-tenant database system.

18. A system comprising:
one or more machines having a processor system including one or more processors;
a storage system having one or more machine-readable media, the storage system storing at least
a multi-tenant relational database,
a downloadable application for managing the multi-tenant relational database; and
the downloadable application including one or more machine instructions, which when implemented by the user mobile device, implements a method including at least:
receiving, by a user mobile device via a client application stored and run on the user mobile device, from a multi-tenant database system, information related to managing the multitenant database system from the user mobile device, the user mobile device including at least a processor system and a memory system;
sending, by the user mobile device, via the client application, to the multi-tenant database system, a message including an instruction to implement an administrative action on the multi-tenant database system.

19. The system of claim 18, wherein the information related to managing a multitenant database includes at least
a status of a datacenter running on the multi-tenant database system;
a status of an instance on a datacenter running on the multi-tenant database system;
access to a user account on the multi-tenant database system;
a status of the multi-tenant database system; and
one or more options to take one or more administrative actions in response to the notification.

20. The system of claim 18, wherein the administrative actions include at least
sending a report of the status, via a network;
implementing remedial actions for datacenters and instances including at least increasing usage limits;
delegating the alert to another user or administrator of the multi-tenant database system;
resetting the user account;
deactivating the user account;
edit user account information;
adding a new user to the multi-tenant database system;
granting user access to the multi-tenant database system; and
manipulating user access to the multi-tenant database system.
